(19) United States
(12) Patent Application Publication
(10) Pub. No.: US 2017/0068926 A1
(43) Pub. Date: Mar. 9, 2017

(54) METHOD AND APPARATUS FOR MANAGING GUEST ROOM

(71) Applicant: SAMSUNG ELECTRONICS CO., LTD., Suwon-si (KR)

(72) Inventors: Chungyong EOM, Seoul (KR); Jieun KIM, Suwon-si (KR); Kwangsu KIM, Suwon-si (KR); Dongbeom LEE, Suwon-si (KR); Jongshik LEE, Seoul (KR); Hyunsuk MIN, Suwon-si (KR); Soobyoung OH, Seongnam-si (KR); Jaeeun KANG, Suwon-si (KR); Changhan KIM, Goyang-si (KR); Jongyoub RYU, Suwon-si (KR)

(21) Appl. No.: 15/260,901

(22) Filed: Sep. 9, 2016

(30) Foreign Application Priority Data
Sep. 9, 2015 (KR) 10-2015-0127831
Dec. 14, 2015 (KR) 10-2015-0178002

(51) Int. Cl. G06Q 10/06

(52) U.S. Cl. CPC G06Q 10/063116; G06Q 10/063118; G06Q 10/063114

(57) ABSTRACT

A method and apparatus for managing a guest room are provided. The method in which a server manages a room in a room management system including at least one terminal and a gateway includes: determining a room status; assigning a housekeeper to the room based on the room status; transmitting room information to a housekeeper terminal; and receiving and updating a housekeeping status from the housekeeper terminal.

### PRIORITY

This application is based on and claims priority under 35 U.S.C. 119 to applications filed in the Korean Intellectual Property Office on Sep. 9, 2015 and Dec. 14, 2015, and assigned Serial Nos. 10-2015-0127831 and 10-2015-0178002, respectively, the contents of which are incorporated by reference herein in their entireties.

### BACKGROUND

Field

The disclosure relates generally to a method and apparatus for managing a guest room, and for example, to a method and apparatus in which a housekeeper of accommodations manages a status of a plurality of rooms within the accommodations, thereby providing a room in an optimal and/or improved status to an accommodation guest.

Description of Related Art

The Internet has been innovated from a human-based connection network in which a human generates and consumes information to an Internet of Things (IoT) network that gives and receives and processes information to and from distributed constituent elements such as things. Internet of Everything (IoE) technology in which big data processing technology through connection to a cloud server is combined with IoT technology have been appeared. In order to implement IoT, technology elements such as sensing technology, wired and wireless communication and network infrastructure, service interface technology, and security technology are required, and nowadays, technology of a sensor network, Machine to Machine (M2M), and Machine Type Communication (MTC) for connection between things have been researched.

In an IoT environment, an intelligent Internet Technology (IT) service that collects and analyzes data generated in connected things to provide a new value to a human life may be provided. IoT may be applied to a field of a smart home, smart building, smart city, smart car or connected car, smart grid, health care, smart home appliances, and high-tech medical service through fusion and complex between existing Information Technology (IT) technology and various industries.

In general, accommodations business indicates business that receives a predetermined rental fee to rent a room. In conventional accommodations business, a plurality of housekeepers are hired to manage a plurality of rooms, and the plurality of housekeepers clean an assigned room and supplement an equipment. However, a status of a plurality of rooms changes in real time, but by uniformly assigning a room and a housekeeping work to a housekeeper without reflecting such a status, there is a problem that housekeeping is inefficiently performed and that an unsatisfactory service is provided to a guest.

### SUMMARY

The disclosure addresses the above problems and provides a method of assigning and managing a room and work to a housekeeper based on a room status or information about the housekeeper. The disclosure further provides a method of dynamically changing and configuring a room management list based on a room type, information received from a gateway within the room, or information input by a housekeeper.

In accordance with an example aspect of the disclosure, a method in which a server manages a room in a room management system including at least one terminal and a gateway includes: determining a room status; assigning a housekeeper to the room based on the room status; transmitting room information to a housekeeper terminal; and receiving and updating a housekeeping status from the housekeeper terminal.

In accordance with another example aspect of the disclosure, a method in which a terminal manages a room in a room management system including at least one terminal and a gateway includes: receiving room information from a server and displaying the room information on a screen; receiving an input that changes a housekeeping status of a room; and transmitting a request for a housekeeping status change of a room to the server in response to the received input.

In accordance with another example aspect of the disclosure, a server that manages a room in a room management system including at least one terminal and a gateway includes: a communication unit including communication circuitry configured to transmit and receive information; and a controller configured to determine a room status and to assign a housekeeper to the room based on the room status and to transmit room information to a housekeeper terminal and to receive and update a housekeeping status from the housekeeper terminal.

In accordance with another example aspect of the disclosure, a terminal that manages a room in a room management system including at least one terminal and a gateway includes: a communication unit including communication circuitry configured to transmit and receive information; a display unit including circuitry configured to determine information and to display at least one item related to the information; and a controller configured to receive the room information from a server to display the room information on a screen and to receive an input that changes a housekeeping status of a room and to transmit a request for a housekeeping status change of the room to the server in response to the received input.

In accordance with another example aspect of the disclosure, a method in which a server maintains a room includes: receiving at least one sensing signal from at least one sensor; determining a management item based on at least one of the received at least one sensing signal; and updating an already generated management list of the room based on the determined management item.

In accordance with another example aspect of the disclosure, a server that manages a room includes: a communication unit including communication circuitry configured to transmit and receive a signal; and a controller configured to receive at least one sensing signal from at least one sensor and to determine a management item based on at least one of the received at least one sensing signal and to update an already generated management list of the room based on the determined management item.

According to the disclosure, in accommodations having a plurality of rooms, housekeepers are disposed to quickly respond to a room status and a housekeeping request of a room guest changing in real time to provide a best and/or improved service to the room guest. Further, a management list on a room basis of a housekeeper and a room inspector is dynamically configured based on a status within the room and thus the housekeeper and the room inspector can efficiently manage the room.

### BRIEF DESCRIPTION OF THE DRAWINGS

The objects, features, and advantages of the disclosure will be more apparent from the following detailed description, taken in conjunction with the accompanying drawings, in which like reference numerals refer to like elements, and wherein:

FIG. 1 is a diagram illustrating an example configuration of a system that manages a room according to an example embodiment;

FIGS. 2A, 2B, and 2C are diagrams illustrating an example function in which a management server manages a room according to an example embodiment;

FIGS. 3A, 3B, and 3C are diagrams illustrating an example function in which a terminal manages a room according to an example embodiment;

FIG. 4 is a message flow diagram illustrating an example method of assigning a housekeeper to a room and managing the room based on a room status according to an example embodiment;

FIGS. 5A and 5B are diagrams illustrating an example method of setting and changing a housekeeping status of a room in a terminal according to an example embodiment;

FIG. 6 is a message flow diagram illustrating an example process of assigning a housekeeper to a room and adjusting room assignment based on a work load when a housekeeping request is input according to an example embodiment;

FIG. 7 is a message flow diagram illustrating an example method of assigning a housekeeper to a room based on location information of a housekeeper when a housekeeping request is input according to an example embodiment;

FIG. 8 is a message flow diagram illustrating an example method of assigning a housekeeper to a room based on work load information of a housekeeper when a housekeeping request is input according to an example embodiment;

FIG. 9 is a message flow diagram illustrating an example method of assigning a housekeeper to a room based on idle time information of a housekeeper when a housekeeping request is input according to an example embodiment;

FIG. 10 is a message flow diagram illustrating an example method of assigning a housekeeper to a room based on evaluation score information of a housekeeper when a housekeeping request is input according to an example embodiment;

FIG. 11 is a message flow diagram illustrating an example method of adjusting assignment of a housekeeper to a room based on work load information of a housekeeper when a room status is changed according to an example embodiment;

FIG. 12 is a message flow diagram illustrating an example method of adjusting room assignment of a housekeeper when a plurality of rooms are assigned to a housekeeper according to an example embodiment;

FIG. 13 is a message flow diagram illustrating an example method of changing a room status based on information in which a housekeeper inputs to a terminal and updating a management list based on a device state according to an example embodiment;

FIGS. 14A and 14B are diagrams illustrating example information for readjusting assignment of a housekeeper according to an example embodiment;

FIGS. 15A, 15B, 15C, and 15D are diagrams illustrating an example method of dynamically configuring a management list in which a management server manages a room according to an example embodiment;

FIG. 16A and FIG. 16B are diagrams illustrating an example method of dynamically configuring a management list based on a sensing signal in which a management server collects within a room according to an example embodiment;

FIG. 17 is a message flow diagram illustrating an example method of dynamically configuring a management list based on user information of a terminal and a sensing signal in which a management server collects within a room according to an example embodiment;

FIG. 18 is a message flow diagram illustrating an example method of dividing and collecting a management list to a plurality of housekeepers within the same room according to an example embodiment;

FIG. 19 is a message flow diagram illustrating an example process in which a housekeeper who manages an already assigned room requests a change of a housekeeper, thereby changing the housekeeper according to an example embodiment;

FIG. 20 is a block diagram illustrating an example internal structure of a server according to an example embodiment; and

FIG. 21 is a block diagram illustrating an example internal structure of a terminal according to an example embodiment.

### DETAILED DESCRIPTION

Hereinafter, various example embodiments of the disclosure will be described in greater detail with reference to the accompanying drawings.

In this description, detailed descriptions of well-known functions and structures incorporated herein may be omitted to avoid obscuring the subject matter of the disclosure.

Similarly, in the attached drawings, some constituent elements may be omitted or may be schematically illustrated. Further, a size of each constituent element does not necessarily reflect an actual size. Like reference numerals designate like elements throughout the description.

The advantages and features of the disclosure and a method of accomplishing them will become more readily apparent from the detailed description given hereinafter together with the accompanying drawings. However, the disclosure is not limited to the following example embodiments but may be implemented in different forms, and the example embodiments are provided to illustrate the disclosure to those skilled in the art, and the disclosure is defined by the scope of claims.

In the various examples, it may be understood that each block of a message flow diagram and combinations of the message flow diagram may be performed by computer program instructions. Because these computer program instructions may be mounted in a processor of a universal computer, a special computer, or other programmable data processing equipment, the instructions performed through a processor of a computer or other programmable data processing equipment generate a means that performs functions described in a block(s) of the message flow diagram. In order to implement a function with a specific method, because these computer program instructions may be stored at a computer available or computer readable memory that can orient a computer or other programmable data processing equipment, instructions stored at the computer available or computer readable memory may produce a production item including an instruction means that performs a function described in block(s) of the message flow diagram. Because computer program instructions may be mounted on a computer or other programmable data processing equipment, a series of operation steps are performed on the computer or other programmable data processing equipment to generate a process executed with the computer, and instructions that perform a computer or other programmable data processing equipment may provide steps for executing functions described in block(s) of a message flow diagram.

Further, each block may represent a portion of a module, segment, or code including at least one executable instruction for executing a specific logical function(s). Further, in several replaceable execution examples, it should be noted that functions described in blocks may be performed regardless of order. For example, two consecutively shown blocks may be substantially simultaneously performed or may be sometimes performed in reverse order based on a corresponding function.

In this case, a term ‘-unit’ used in the example embodiments may refer, for example, to a software or hardware component such as various processing circuitry (e.g., a CPU), FPGA or ASIC and performs any function. However, ‘-unit’ is not limited to software or hardware. ‘-unit’ may be formed to store at a storage medium that can address and may be formed to reproduce at least one processor. Therefore, for example, ‘-unit’ includes components such as software components, object-oriented software components, class components, and task components, processes, functions, attributes, procedures, subroutines, segments of a program code, drivers, firmware, microcode, circuit, data, database, data structures, tables, arrays, and variables. A function provided within constituent elements and ‘-units’ may be performed by coupling the smaller number of constituent elements and ‘-units’ or by subdividing into additional constituent elements and ‘-units’. Further, constituent elements and ‘-units’ may be implemented to reproduce at least one CPU within a device or a security multimedia card.

For reference, in the example embodiments, a “housekeeper” may manage a room and provides a service to a room and performs a work of room cleaning and maintenance of a facility, furniture and an equipment of a room.

Further, in the example embodiments, a “room inspector” may evaluate an execution result of a housekeeping work of the housekeeper and a housekeeping status of a room.

Further, in the example embodiments, a “manager” may manage manpower including the housekeeper and the room inspector and maintains and may manage an entire service status.

Further, in the example embodiments, a “room status” may, for example, indicate a room status related to a guest within a room and may include, for example, check-in, check-out, Do Not Disturb (DND), and Make Up Room (MUR).

Further, in the example embodiments, a “housekeeping status of a room” may, for example, indicate a housekeeping status and an available status of a housekeeper and may include, for example, Dirty (check-in and status requiring housekeeping), Departed Dirty (check-out and status requiring housekeeping), Ongoing (housekeeping state), Cleaned (housekeeping completion), Inspected (inspection completion), Pickup (temporary sale postponement), Out of Service (sale unavailable status during one-three week), and Out of Order (sale unavailable status during one-two day).

Further, in the example embodiments, a “management list” may, for example, include a management item in which a housekeeper, room inspector, and manager can use for housekeeping.

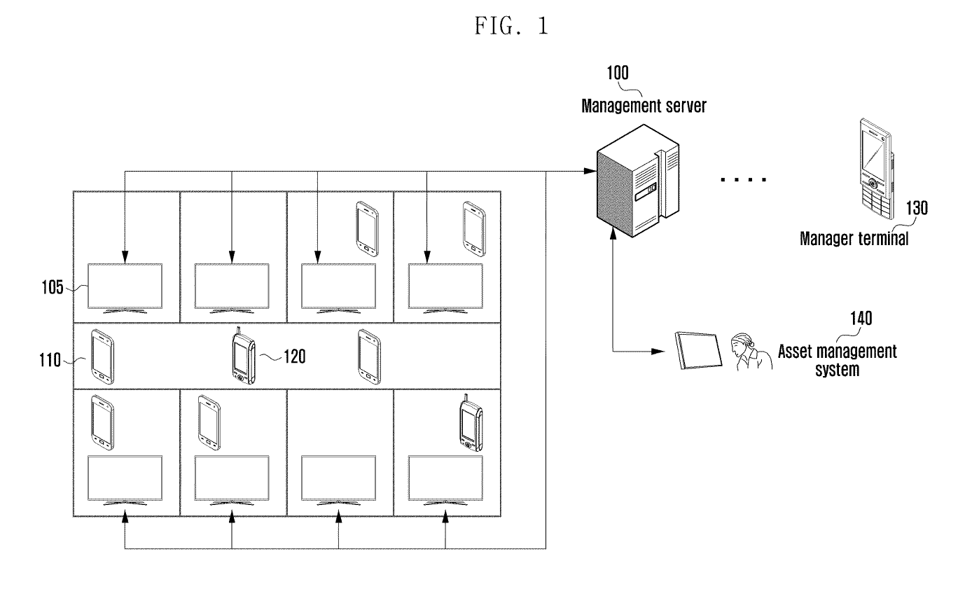

FIG. 1 is a diagram illustrating an example configuration of a system that manages a room according to an example embodiment.

The system that manages a room may include a management server 100, room gateway 105 connected to the management server 100, housekeeper terminal 110, room inspector terminal 120, manager terminal 130, and asset management system 140.

The management server 100 may be connected to the housekeeper terminal 110, room inspector terminal 120, and manager terminal 130 to generate and transmit information necessary for managing the room. The management server 100 may assign a housekeeper to the room based on a room status. Further, the management server 100 may set and change a housekeeping status of a room. Further, when a request for housekeeping is input, for example, by a room guest, the management server 100 may assign a housekeeper to the room and adjust room assignment based on a work load.

Further, when a request for housekeeping is input by a gateway within the room, the management server 100 may assign a housekeeper to the room based on location information, work load information, and idle time information of a housekeeper or an evaluation score of the housekeeper. Further, when a room status is changed, the management server 100 may adjust assignment of housekeeper to the room based on work load information of a housekeeper.

Further, when a plurality of rooms are assigned to a housekeeper, the management server 100 may adjust room assignment of the housekeeper. Further, the management server 100 may change a room status based on information in which a housekeeper inputs to a terminal and dynamically update a management list based on a device state. The management list may include, for example, a management item in which a housekeeper, room inspector, and manager can use for housekeeping. Further, the housekeeper may input a room dirty level, and the management server 100 may determine a housekeeping status of a room based on a housekeeper location.

Further, the management server 100 may dynamically configure a management list that manages a room. The management server 100 may determine a management item including a management area based on a sensing signal received from a sensor within the room and dynamically configure the management list. The management server 100 may dynamically configure the management list based on a sensing signal received from a sensor within the room and user information of a terminal that requests a room list and transmit the management list to the terminal. Further, in the example embodiments, the management server 100 may divide a management list within the same room, distribute the management list to a plurality of housekeepers, and collect the management list. Further, when a request for a housekeeper change transmitted by a housekeeper who manages the assigned room is received, the management server 100 may change the housekeeper.

The room gateway 105 connected to the management server 100 may perform a gateway function in a room. For example, the room gateway 105 may be connected to several devices within the room to collect information about the devices. Further, the room gateway 105 may receive an input of a request for a room status change from a room guest. For example, the room gateway 105 may receive an input of a request for a change to DND or MUR from the room guest.

The housekeeper terminal 110, room inspector terminal 120, and manager terminal 130 may display information received from the management server 100. The information may include room information and information about a room status or a housekeeping status. Further, the housekeeper terminal 110, room inspector terminal 120, and manager terminal 130 may receive a request for a housekeeping status change from the housekeeper, room inspector, and manager and transmit the request to the management server 100. Further, the housekeeper terminal 110 and the room inspector terminal 120 may transmit information about a location of a housekeeper and a room inspector to the management server 100.

The asset management system 140 manages information about devices within a room. The device within a room may include electronic devices and equipments within the room. The asset management system 140 may receive information about devices within the room collected by the room gateway 105 from the management server and display the information.

A terminal according to an example embodiment of the disclosure may include a mobile terminal, smart phone, laptop computer, tablet Personal Computer (PC), electronic book terminal, digital broadcasting terminal, Personal Digital Assistants (PDA), Portable Multimedia Player (PMP), navigation device, and smart television, or the like, but the disclosure is not limited thereto and may be implemented in various forms.

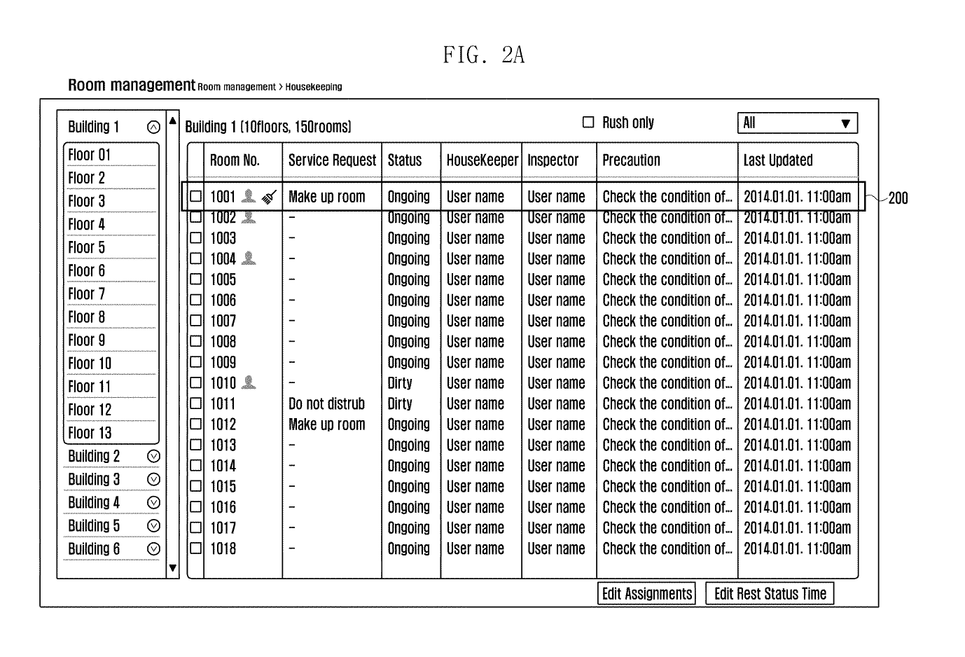

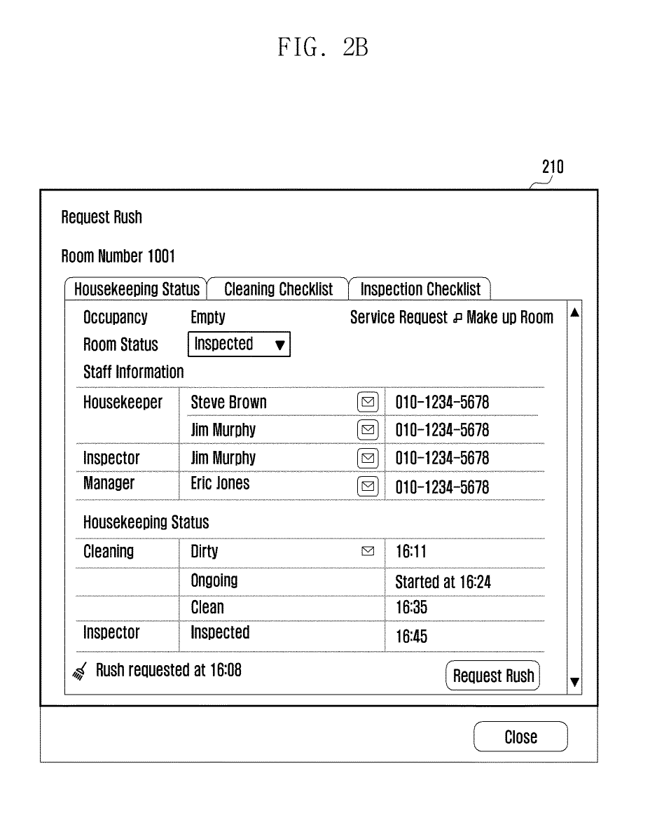

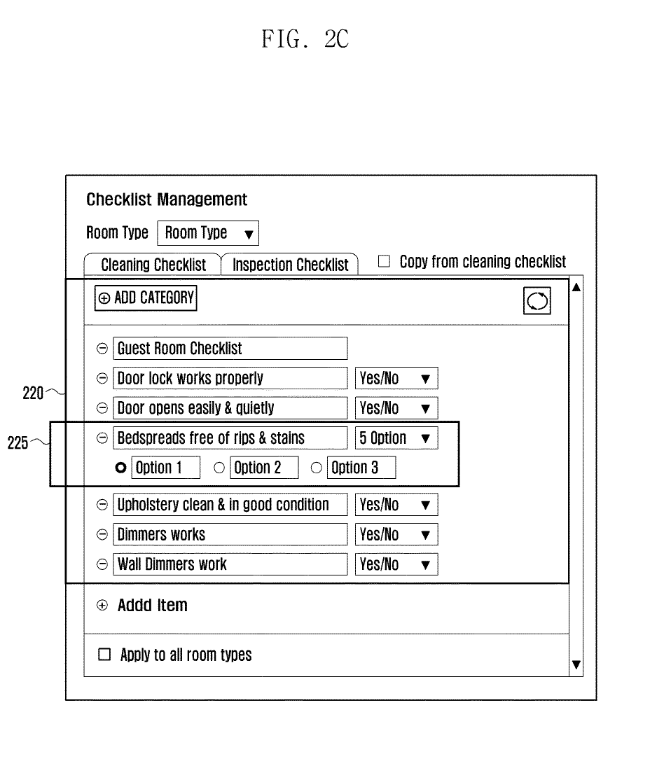

FIGS. 2A, 2B, and 2C are diagrams illustrating an example function in which a management server manages a room according to an example embodiment.

For example, FIG. 2A illustrates an example screen in which a monitoring device accessed to a management server displays room status information and assignment information of a housekeeper or a room inspector of each room stored at a database of the management server. Referring to FIG. 2A, displayed room information may include a room status including whether a service request is input, a housekeeping status of a room, a room housekeeper, and a room inspector according to a room number.

Further, FIG. 2B illustrates a screen 210 that displays detailed information of a room displayed when selecting, for example, reference numeral 200 of FIG. 2A. Referring to FIG. 2B, displayed room detailed information may include a name or a phone number of a housekeeper and a room inspector and history information of a housekeeping status of a room in addition to room information of FIG. 2A.

Further, FIG. 2C illustrates a screen in which a monitoring device accessed by a management server generates or edits a management list of a work in which the housekeeper or the room inspector is to perform. Referring to FIG. 2C, displayed management list information may include information about a category 220 of a management list, management item 225, and an input value or an option on a management item.

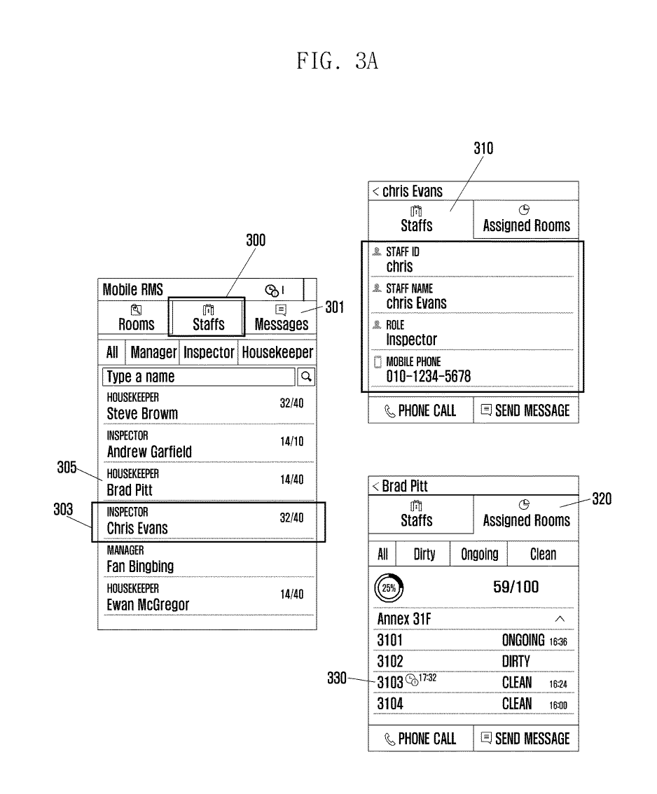

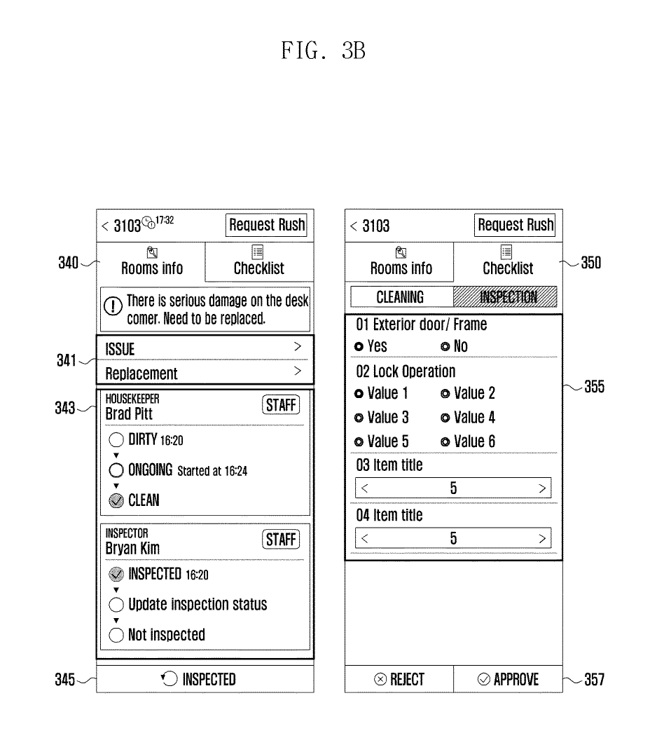

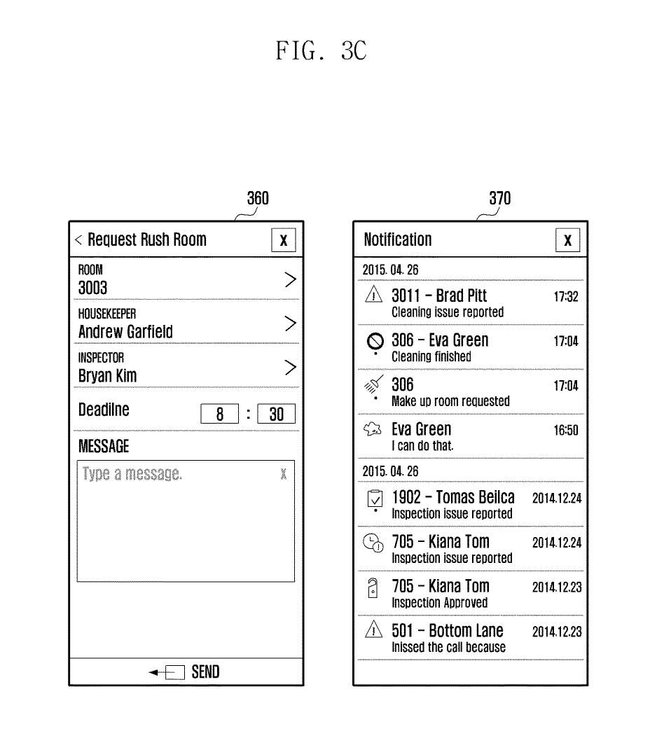

FIGS. 3A, 3B, and 3C are diagrams illustrating an example function in which a terminal manages a room and a housekeeper according to an example embodiment.

For example, FIGS. 3A, 3B, and 3C are diagrams illustrating a mobile Room Management System (RMS) which a housekeeper, room inspector, and manager may use. The mobile RMS may be installed and implemented as an application in a terminal of the housekeeper, room inspector, and manager.

FIG. 3A is a diagram illustrating an example screen of a terminal that can inquire about manpower information and a work load on manpower basis. When receiving an input that selects staffs 300 tab of the upper end of the screen from a user, the terminal may display a list of staffs registered at accommodations. Information displayed on the screen may include a name, role (housekeeper, room inspector, or manager), and work load of staffs. For example, the work load may represent the housekeeping completion room number to the room number assigned to a housekeeper or a room inspector. When a name of the staffs is touched, the mobile RMS may provide detailed information of the staffs and a function of communication/message. For example, when a terminal user selects Chris Evans 303, which is a room inspector, shown staff information 310 may include ID, a name, a role, and a phone number of a staff. Further, when a terminal user selects Brad Pitt 305, which is a housekeeper and assigned room tab (assigned rooms) 320, displayed information may display the assignment room number, the cleaning completion room number, a rate of the cleaning completion room number to the assignment room number, and information about a recent room cleaning history.

FIG. 3B is a diagram illustrating an example screen of a terminal that can determine room current status management and a management list. As illustrated in FIG. 3A, when a terminal user receives an input that selects a room number 3103 in a room tab 320 assigned to staffs 330, the terminal may display a room current status information tab 340 and a management list tab 350. When receiving an input that selects the room current status information tab 340 from the terminal, the terminal may display issue information that briefly includes room unusual contents or confirmation contents and replacement information that manages an equipment exchange current status (341). Further, the terminal may display information about a housekeeper and room inspector of a corresponding room and display a housekeeping status and management history information thereof (343). Further, the terminal may display a present housekeeping status of a room (345).

Further, when receiving an input that selects the management list tab 350 from a terminal user, the terminal provides a function of inquiring and determining a management list of a corresponding room, and the management list may include a list edited in the management server. Information displayed in the management list may include a management list category, management item, and value or option information on a management item basis (355). Further, when a terminal user is a manager having a management authority over housekeeping, the terminal may display a menu that selects whether to approve or reject an edition state of a management item of the management list (357).

FIG. 3C is a diagram illustrating an example screen of a terminal that displays a function of transmitting and receiving a message between staffs providing in a mobile RMS. When a user selects a message tab 301 of FIG. 3A, the terminal may display a screen for transmitting a message (360). The terminal user may transmit a message that requests housekeeping as well as a general message at the screen. In this example, as illustrated in reference numeral 360, the terminal may display a room number related to a message and information about a housekeeper and a room inspector of the room and together display a screen for inputting a housekeeping request deadline and a message.

Further, when a message is received by the user, the terminal may display the received message (370). When the terminal lists messages in received time order and receives an input in which the user selects the message, the terminal may display detailed information of the message.

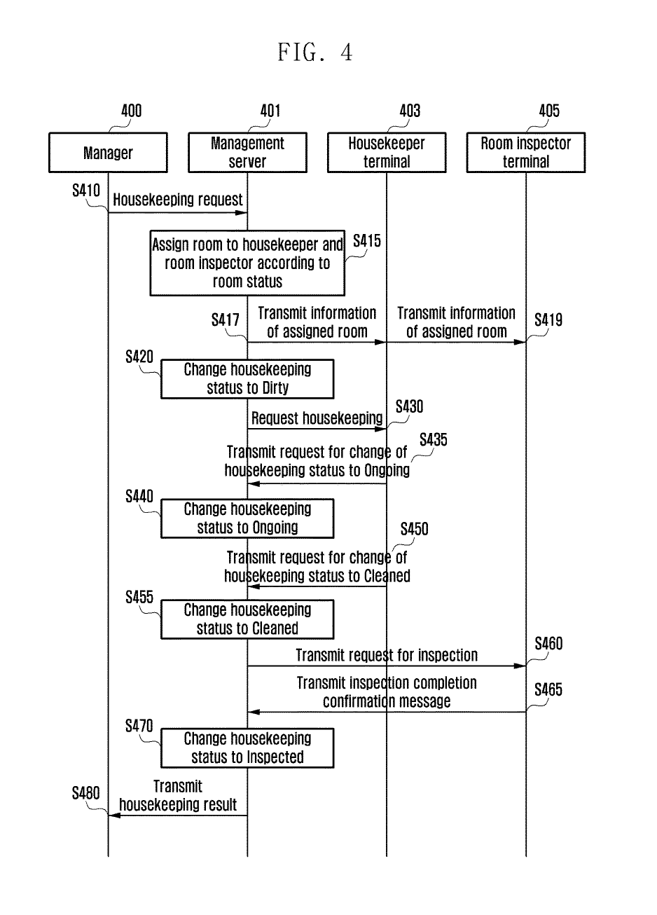

FIG. 4 is a message flow diagram illustrating an example method of assigning a room to a housekeeper based on a room status according to an example embodiment.

A manager 400 may transmit a housekeeping request to a management server 401 at step S410. The management server 401, having received the housekeeping request may assign a room to a housekeeper and a room inspector according to a room status at step S415. The room status indicates a room status related to a guest within the room and may include, for example check-in, check-out, Do Not Disturb (DND), and Make Up Room (MUR). The management server 401 may transmit information of an assigned room to a terminal 403 of a housekeeper to which a room is assigned at step S417 and transmit information of an assigned room to a terminal 405 of a room inspector to which a room is assigned at step S419.

Thereafter, the management server 401 may change a housekeeping status of the assigned room to Dirty, which is a basic value at step S420. Thereafter, the management server 401 may request housekeeping to the housekeeper terminal 403 at step S430. When the housekeeper terminal 403 receives an input that changes a housekeeping status to Ongoing from the housekeeper, the housekeeper terminal 403 may transmit a request for a housekeeping status change to Ongoing to the management server 401 at step S435. The management server 401, having received the message may change a housekeeping status of the room to Ongoing at step S440. Thereafter, when the housekeeper terminal 403 receives an input that changes a housekeeping status to Cleaned from the housekeeper, the housekeeper terminal 403 may transmit a request for a housekeeping status change to Cleaned to the management server 401 at step S450, and the management server 401 may change a housekeeping status of the room to Cleaned in response to the request at step S455.

Thereafter, the management server 401 may transmit a request for an inspection of a room in which housekeeping is complete to the terminal 405 of a room inspector to which a corresponding room is assigned at step S460. When receiving an input that an inspection has been complete from the room inspector, the room inspector terminal 405 may transmit an inspection completion confirmation message to the management server 401 at step S465, and the management server 401 may change a housekeeping status to Inspected in response thereto at step S470. Further, the management server 401 may transmit a housekeeping result to the manager terminal 400 at step S480.

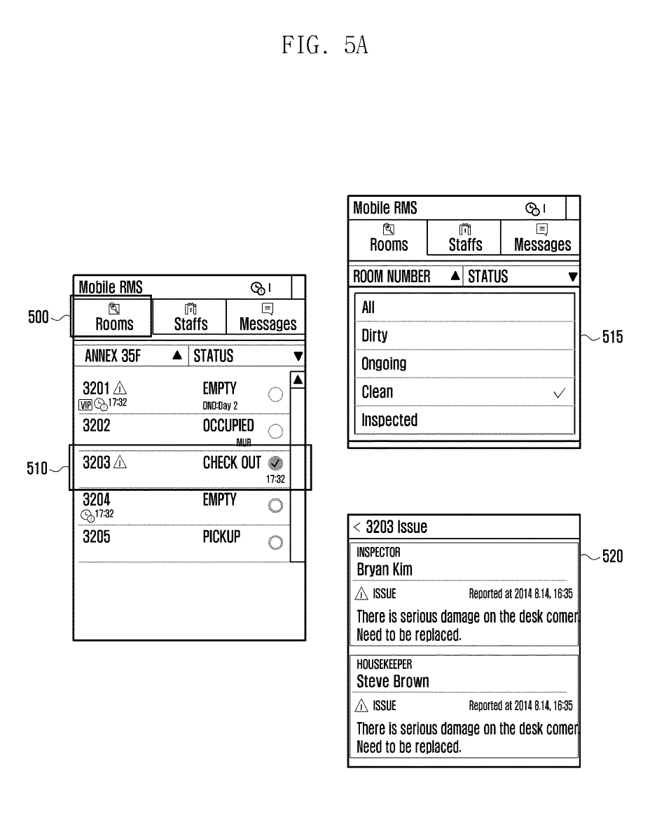

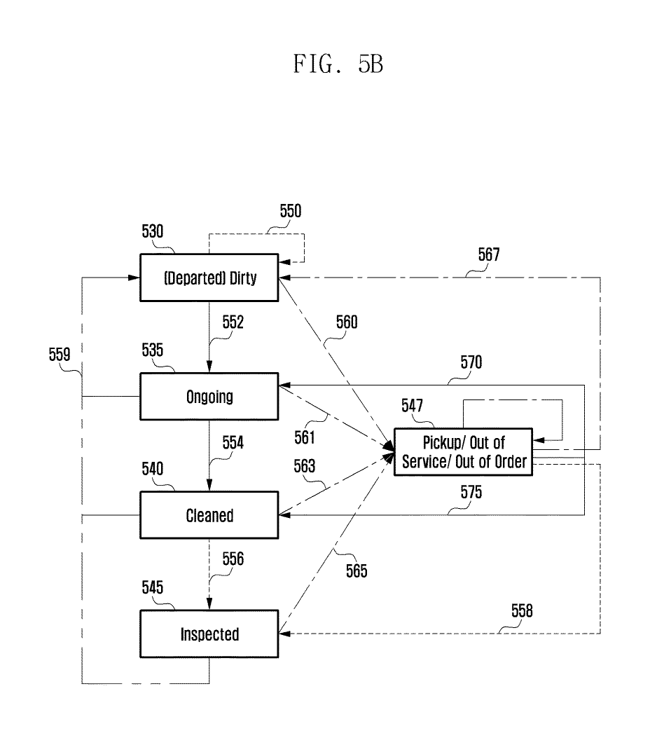

FIGS. 5A and 5B are diagrams illustrating an example method of setting and changing a housekeeping status of a room in a terminal according to an example embodiment.

For example, FIG. 5A is a diagram illustrating a screen in which a housekeeper, room inspector, and manager can manage a room list and a housekeeping status of a room through a mobile RMS of a terminal.

Hereinafter, the housekeeper, room inspector, and manager who manage a room using a terminal may be referred to as a terminal user.

In FIG. 5A, when receives an input in which a terminal user selects a room tab 500, a terminal may inquire and display a list and a room status of each room. Further, when receiving an input that touches one room 510 of the room list from the user, the terminal may display a screen 515 that inquires and changes a housekeeping status of the room. The user may select a housekeeping status on the screen 515. Further, the terminal may give a limited authority that can change a housekeeping status based on a role of the users to the users. For example, the terminal enables the housekeeper to select only Ongoing and Cleaned, which are a housekeeping status related to direct housekeeping such as cleaning of a room, enables the room inspector to select only a basic value and Dirty and Inspected, which are a housekeeping status related to inspection, and enables the manager to change an entire status.

Further, when detecting operation in which the user, for example, double taps one room 510 in a room list or taps for a predetermined time or more, the terminal may display a screen 520 that inquires or edits detailed information of the room.

FIG. 5B is a diagram illustrating an example authority that changes a housekeeping status of a room given to the user.

The housekeeping status of a room may include (Departed) Dirty 530, Ongoing 535, Cleaned 540, Inspected 545, and Pickup/Out of Service/Out of Order 547. The Dirty 530 may represent a check-in status and a status requiring cleaning of a room, the Departed Dirty 530 may represent a check-out status and a status requiring cleaning of a room. The Ongoing 535 may represent a housekeeping state, the Cleaned 540 may represent a housekeeping completion state, the Inspected 545 may represent an inspection completion state, the Pickup 547 may represent temporary sale postponement, the Out of Service 547 may represent a sale unavailable status during one-three week, and the Out of Order 547 may represent a sale unavailable status during one-two day.

With respect to a change of each status, a housekeeper, room inspector, and manager has an authority that can change a housekeeping status based on a role thereof. For example, only the housekeeper may change a housekeeping status to Ongoing 535 and Cleaned 540 (552, 554, 570, and 575). Further, only the room inspector may change a housekeeping status to Inspected 545 (556, 558). Further, only the manager may change from each state of a room to Pickup/Out of Service/Out of Order 547 related to a sale status of a room (560,561,563,565) or may sell and may change a room status to Dirty 530, which is a basic value (567). Further, when a predetermined time has elapsed or when a guest checks in or checks out, the RMS may change a room state to a basic state (550, 559).

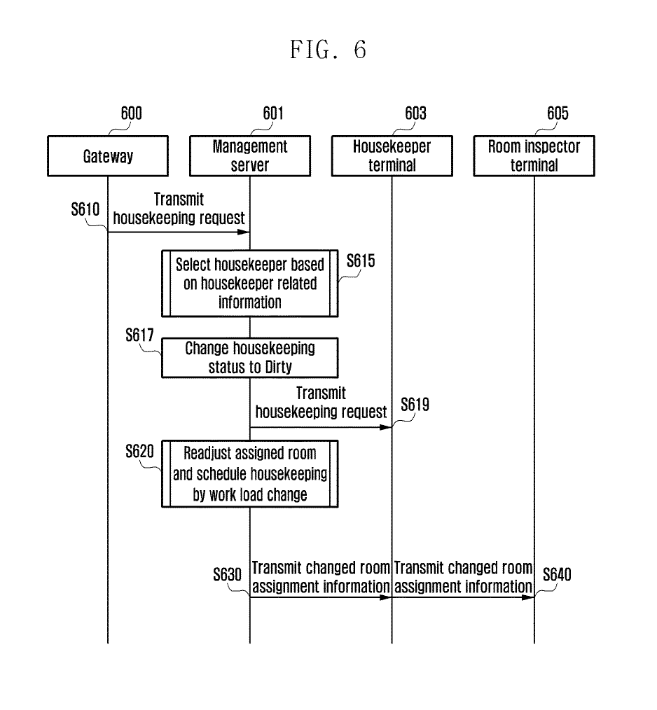

FIG. 6 is a message flow diagram illustrating an example process of assigning a housekeeper to the room and adjusting room assignment based on a work load when a housekeeping request is input according to an example embodiment.

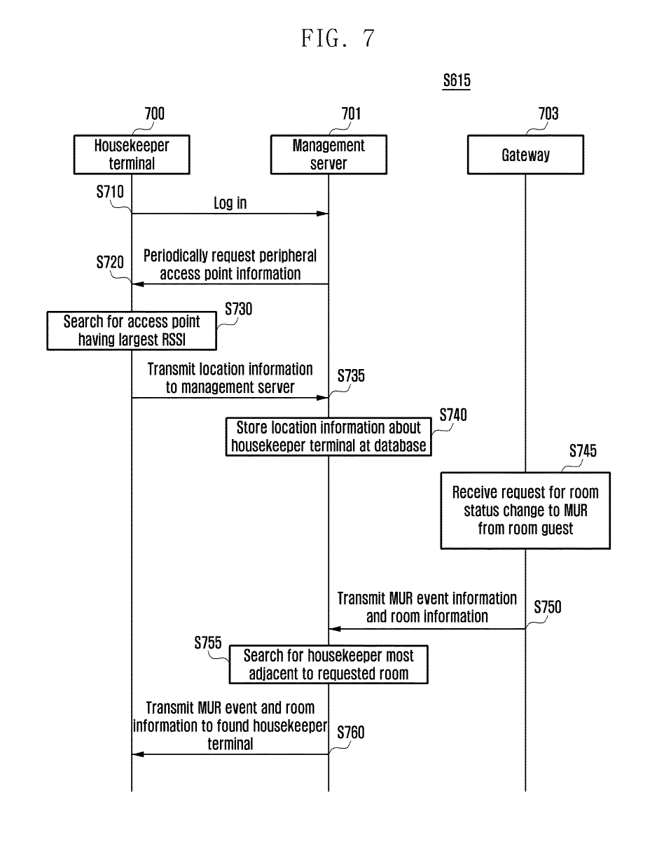

A gateway 600 may transmit a housekeeping request to a management server 601 at step S610. The management server 601 may select a housekeeper based on housekeeper related information in response to the housekeeping request at step S615. In this example, the management server 601 may select a housekeeper to housekeep the room based on at least one of a location, work load, idle time, and evaluation score of housekeepers. Each operation will be described in greater detail below with reference to FIGS. 7 to 10.

Thereafter, the management server 601 may change a housekeeping status to Dirty, which is a basic value at step S617. Thereafter, the management server 601 may transmit a housekeeping request to a selected housekeeper terminal 603 at step S619. Further, the management server 601 may periodically monitor a work load change of housekeepers, readjust an assigned room, and schedule housekeeping according to the work load change at step S620. Thereafter, the management server 601 may transmit room assignment information changed in the process to the housekeeper terminal 603 at step S630 and transmit room assignment information changed in the process to a room inspector terminal 605 at step S640. Thereafter, operation in which the housekeeper changes a housekeeping status while housekeeping a room and in which the room inspector inspects a room is the same as that of step S420 and subsequent steps of FIG. 4.

FIG. 7 is a message flow diagram illustrating an example method of assigning a housekeeper to a room based on location information of a housekeeper when a housekeeping request is input according to an example embodiment.

FIG. 7 is a message flow diagram illustrating an example embodiment of step S615 of FIG. 6. For example, the management server 701 collects indoor information location through a terminal of all housekeepers and room inspectors, and when a housekeeping request is input, the management server efficiently assigns housekeeping to a housekeeper adjacent to a room. Indoor Positioning technology uses a WLAN-based Access Point (AP) equipment and assumes that an access point is installed on each floor and major facility unit basis within accommodations. Each access point within accommodations has a distinguishing service set identifier (SSID) and Medium Access Control (MAC) address. The management server has a preset database about entire AP list installed within accommodations and location information on an AP basis. The AP information may include an SSID, an MAC Address, and location information (floor or facility unit).

A housekeeper terminal 700 may log in to a management server 701 through the mobile RMS at step S710. Thereafter, the management server 701 may periodically request peripheral access point information from the housekeeper terminal 700 at step S720. The housekeeper terminal 700 may search for an access point, for example, an access point having largest Received Signal Strength Indication (RSSI) in response to the request at step S730. Further, the housekeeper terminal 700 may transmit a housekeeper's location information based on the found access point information to the management server 701 at step S735. The housekeeper's location information may, for example, include the housekeeper's ID, access point information (SSID, MAC address), and information about an access time. The management server 701 may identify indoor location information based on the access point information and may store location information about the housekeeper terminal at a database at step S740.

Thereafter, when a gateway 703 receives an input of a request for a room status change to MUR from, for example, a room guest at step S745, the gateway 703 may transmit the received MUR event information and room information to the management server 701 at step S750. The management server 701 may search for a most adjacent housekeeper based on the stored location information in response thereto at step S755. For example, the management server 701 may preferentially select housekeepers located at a floor corresponding to a room number of requested room information. When a housekeeper is not present at a corresponding floor, the management server 701 may widen a range in order of requested rooms and search for a housekeeper. Thereafter, the management server 701 may determine whether a present status of found housekeepers is an idle status and finally select a housekeeper in an idle status. Thereafter, the management server 701 may transmit MUR event and room information to the found housekeeper terminal at step S760.

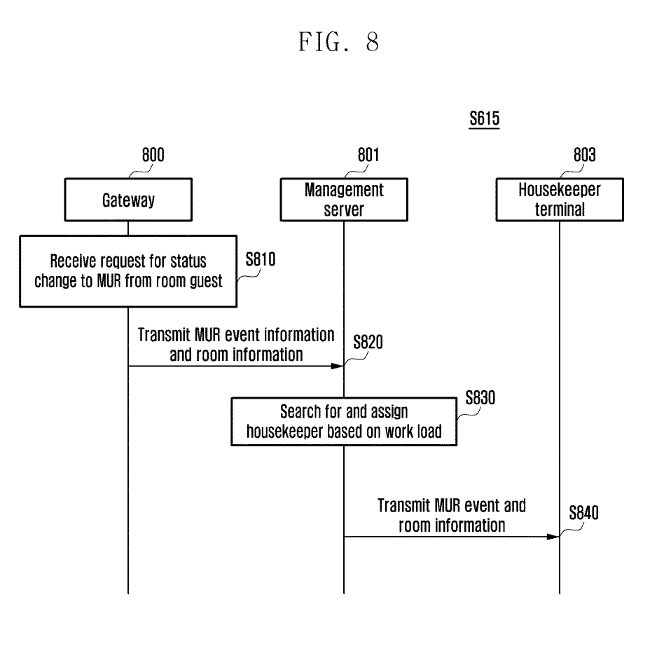

FIG. 8 is a message flow diagram illustrating an example method of assigning a housekeeper to a room based on work load information of a housekeeper when a housekeeping request is input according to an example embodiment.

FIG. 8 is a message flow diagram illustrating an example embodiment of step S615 of FIG. 6. For example, FIG. 8 is a message flow diagram illustrating an example method of comparing work loads of housekeepers and assigning a work to a housekeeper having a smallest work load.

When the housekeeper performs a housekeeping work, a mobile RMS of a housekeeper terminal may change a housekeeping status of a corresponding room to Ongoing, change a housekeeping status of a corresponding room to Cleaned after housekeeping is complete, transmit management history information including a changed time to a management server, and store the management history information at a database.

When a gateway 800 receives a request for a status change to MUR from a room guest at step S810, the gateway 800 may transmit MUR event information and room information to a management server 801 at step S820. Thereafter, the management server 801 may search for and assign a housekeeper based on a work load at step S830. A work load of each housekeeper may be determined as work strength according to a time reference or work strength according to a room type and the room number reference. For example:

Work load based on time=housekeeping time/entire work time of housekeeper (1-1)

(The housekeeping time represents the sum of an Ongoing state input time to Cleaned state input time of an entire Cleaned room, and an entire work time of the housekeeper represents a work start time to a termination time)

Work load based on room type and the room number=Σ(the sum of the entire room number in which housekeeping is complete×work load weight value on room type basis) (1-2)

(A quantified weight value of a housekeeping work load on room type basis may be previously set: Standard=1/Deluxe=1.2/Suite=1.5)

The management server 801 may determine the work strength and preferentially assign a room to a housekeeper having a smallest work load. Thereafter, the management server 801 may transmit MUR event and room information to a housekeeper terminal 803 at step S840.

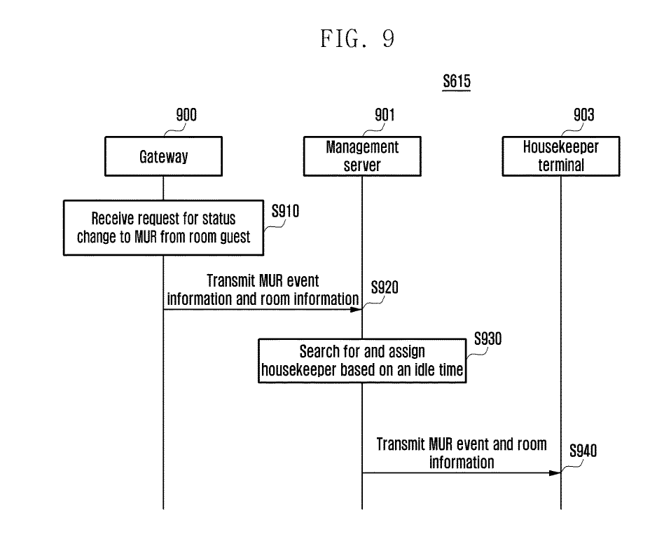

FIG. 9 is a message flow diagram illustrating an example method of assigning a housekeeper to the room based on idle time information of a housekeeper when a housekeeping request is input according to an example embodiment.

FIG. 9 is a message flow diagram illustrating an example embodiment of step S615 of FIG. 6. For example, FIG. 9 is a message flow diagram illustrating a method in which a management server collects room cleaning details of all housekeepers, determines an idle time of each housekeeper, and assigns a room to housekeeper having a largest idle time, when a housekeeping request is input.

When the housekeeper performs a housekeeping work, a mobile RMS of a housekeeper terminal may change a housekeeping status of a corresponding room to Ongoing, change a housekeeping status of a corresponding room to Cleaned after housekeeping is complete, transmit management history information including a changed time to the management server, and store the management history information at a database. When receiving a request for a status change to MUR from a room guest at step S910, a gateway 900 may transmit MUR event information and room information to a management server 901 at step S920.

Thereafter, the management server 901 may search for and assign a housekeeper based on an idle time at step S930. A method of determining the idle time may, for example, be as follows.

Idle time based on entire work time=(entire work time of housekeeper)−(the sum of cleaning time of each room(Cleaned input time−Ongoing input time)) (2-1)

Idle time based on recent room cleaning completion time=room service request time−(recent room cleaning completion time(Cleaned input time)) (2-2)

The management server 901 may determine the idle time and preferentially assign a room to a housekeeper having a longest idle time. Thereafter, the management server 901 may transmit MUR event and room information to a housekeeper terminal 903 at step S940.

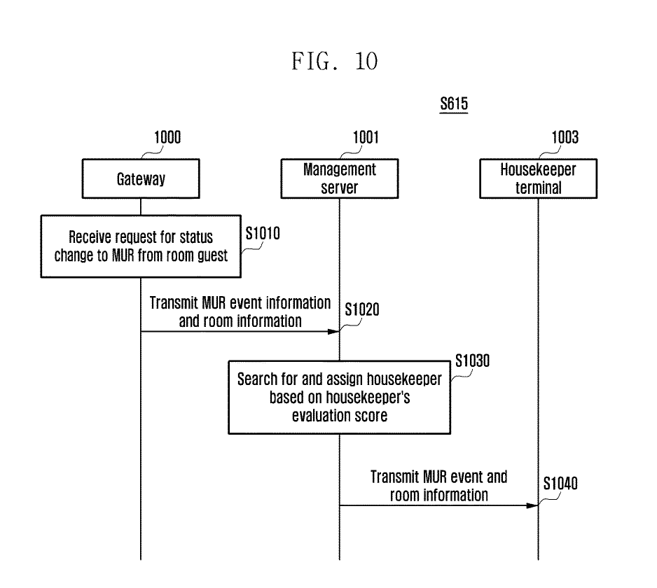

FIG. 10 is a message flow diagram illustrating an example method of assigning a housekeeper to a room based on evaluation score information of a housekeeper when a housekeeping request is input according to an example embodiment.

FIG. 10 is a message flow diagram illustrating an example embodiment of step S615 of FIG. 6. For example, FIG. 10 is a message flow diagram illustrating a method in which a management server collects room cleaning details of all housekeepers and room inspection details of a room inspector, determines an evaluation score of each housekeeper, and assigns a room to the housekeeper in evaluation score order when a housekeeping request is input. An evaluation score is given to the housekeeper based on a room cleaning state and satisfaction of a room guest based on a management list written by a room inspector.

An example of deriving an evaluation score based on a management list written by the room inspector will be described. The room inspector may inspect whether a housekeeper cleans each room based on a management list, change a room status to an inspection completion state according to an inspection result, and record an inspection result. When it is assumed that an objective and standardized index exists on a management list basis, upon inspecting a room, the room inspector may give an evaluation score to the housekeeper based on an index of a room cleaning state based on a management list. For example, the evaluation item may include cleanliness of a room, completeness of a management list item written by a housekeeper, and a housekeeping time.

Thereafter, when an evaluation score is derived based on satisfaction of a room guest, an evaluation score of a housekeeper may be given based on satisfaction of the housekeeper's housekeeping during a stay period of a room guest in which a room inspector conducts a survey to the room guest. Further, the evaluation score may be derived in consideration of a management list and satisfaction of a room guest according to a predetermined weight value.

When receiving a request for a status change to MUR from a room guest at step S1010, a gateway 1000 may transmit MUR event information and room information to a management server 1001 at step S1020.

Thereafter, as described above, the management server 1001 may search for and assign a housekeeper based on a housekeeper's derived evaluation score at step S1030. Thereafter, the management server 1001 may transmit MUR event and room information to a housekeeper terminal 1003 at step S1040.

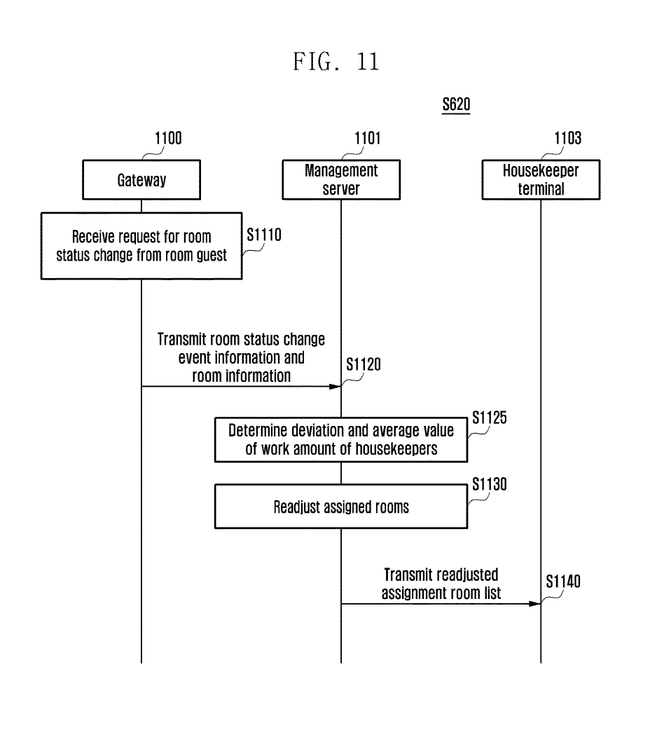

FIG. 11 is a message flow diagram illustrating an example method of adjusting assignment of a housekeeper to a room based on work load information of a housekeeper when a room status is changed according to an example embodiment.

For example, FIG. 11 is a message flow diagram illustrating an example embodiment of S620 of FIG. 6 and is a message flow diagram illustrating an example method of readjusting a work to uniformly set a work load of housekeepers in consideration that a housekeeper's work load is changed based on a room status change.

In a case of comparing workloads according to a room status and a housekeeping status, for example a room of a MUR state requires urgency and thus a work load increases. Further, a room of a check-out state has a large work load upon initial housekeeping, but thereafter, when a room status is changed to a sale unavailable state, a work load may be reduced. Further, a room in a DND state has no work load. A work load weight value on a room status basis may be set based on a room status. For example, when a weight value of a work load of common housekeeping is 1, a weight value 1.2 may be given to a MUR room, a weight value 1 may be initially given to a check-out room, and when a room status of the room is changed to a sale unavailable state, a weight value 0.5 may be given to the room, and a weight value 0 may be given to a DND room.

Further, as described above, a method of readjusting a work of a housekeeper may include a method of readjusting periodically a housekeeping work and a method of readjusting a work when a room status change event occurs. First, a method of periodically readjusting a housekeeping work will be described. The management server may periodically determine a work load of housekeepers in consideration of the above-described weight value based on an entire room status. Thereafter, the management server may set a deviation and an average value of a work load of each housekeeper and may readjust and assign a room in order to converge a work load of the each housekeeper to an average value.

Thereafter, a method of readjusting a work when a room status change event occurs will be described. As illustrated in FIG. 11, when a gateway 1100 receives a request for a room status change from a room guest at step S1110, the gateway 1100 may transmit room status change event information and room information to a management server 1101 in response thereto at step S1120. Thereafter, as described above, the management server 1101 may determine a deviation and average value of a work amount of housekeepers at step S1125 and readjust rooms assigned to housekeepers based on the calculated deviation and average value at step S1130. Thereafter, the management server 1101 may transmit a readjusted assignment room list to a housekeeper terminal 1103 at step S1140.

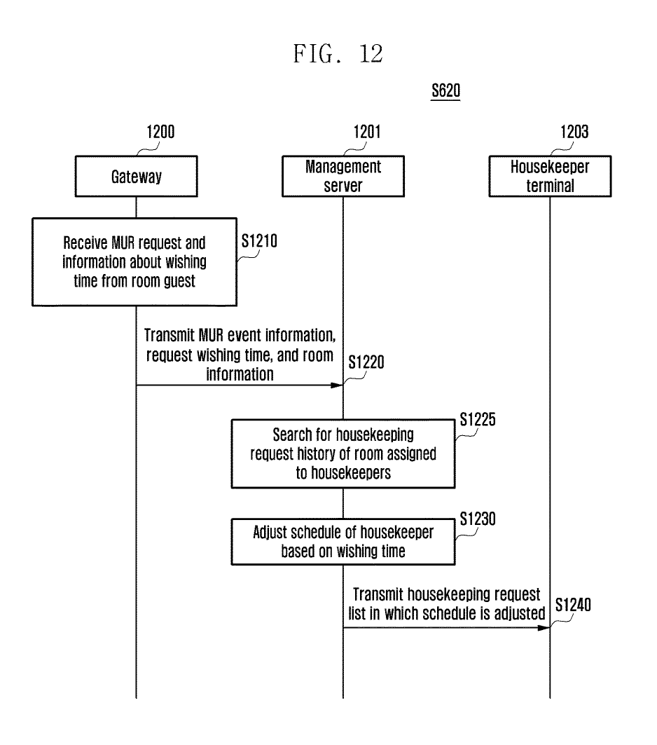

FIG. 12 is a message flow diagram illustrating an example method of adjusting room assignment of a housekeeper when a plurality of rooms are assigned to a housekeeper according to an example embodiment.

For example, FIG. 12 is an example embodiment of step S620 of FIG. 6 and illustrates a method of assigning a plurality of rooms to a housekeeper and scheduling for processing an assigned work when receiving a housekeeping request from a room guest. The scheduling method includes a method of scheduling based on a request time and a method of scheduling based on a requested room and a housekeeper's location. FIG. 11 illustrates a method of scheduling based on a request time, but a person of ordinary skill in the art may apply a method of scheduling based on a housekeeper's location by easily changing the method of scheduling based on a request time.

A gateway 1200 may receive a MUR request and information about a wishing time from a room guest at step S1210. The gateway 1200 may transmit MUR event information, a requested wishing time, and room information to a management server 1201 in response thereto at step S1220. Thereafter, the management server 1201 may search for a housekeeping request history of a room assigned to housekeepers at step S1225. Thereafter, the management server 1201 may adjust a schedule of a housekeeper based on already assigned housekeeping requests and a MUR request wishing time at step S1230.

When a housekeeping request already assigned to a housekeeper is the plural number, the management server 1201 may compare a MUR request wishing time and a housekeeping request time. In this case, when a MUR request wishing time is earlier requested, the management server 1201 may preferentially schedule the MUR request room, and in other cases, the management server 1201 may schedule the MUR request room after an existing housekeeping request assigned to a housekeeper. The management server 1201 may transmit a housekeeping request list in which a schedule is adjusted to a housekeeper terminal 1203 at step S1240.

When the management server 1201 schedules based on a housekeeper's location, the gateway 1200 may together transmit room information including a room number of a requested room guest as well as MUR event information to the management server 1201 at step S1220. The management server 1201 may collect indoor location information from a present housekeeper terminal, compare a housekeeper location and a room location, and schedule from a most adjacent room.

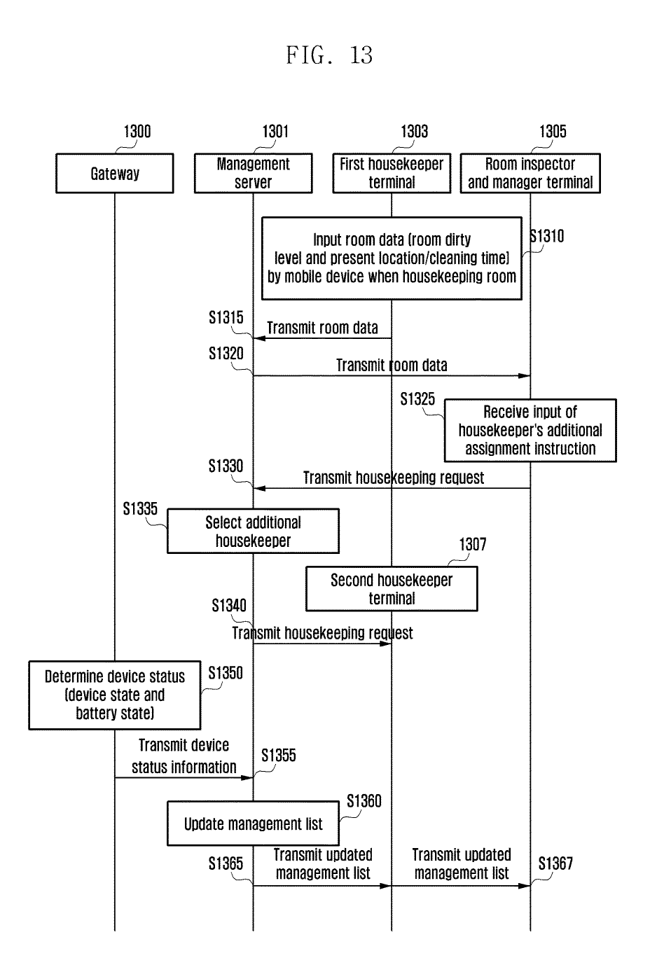

FIG. 13 is a message flow diagram illustrating an example method of changing a room status based on information in which a housekeeper inputs to a terminal and updating a management list based on a device state according to an example embodiment.

When housekeeping a room, a first housekeeper terminal 1303 may input room data by mobile device at step S1310. The room data may include information about a room dirty level, a present location, and a cleaning time. The first housekeeper terminal 1303 may transmit room data to a management server 1301 at step S1315, and the management server 1301, having received the room data may transmit the received room data to a room inspector and manager terminal 1305 at step S1320.

When the room inspector and manager terminal 1305 receives an input of a housekeeper's additional assignment instruction from a room inspector and a manager at step S1325, the room inspector and manager terminal 1305 may transmit a housekeeping request including such an instruction to the management server 1301 at step S1330.

The management server 1301 may select an additional housekeeper in response thereto at step S1335 and may transmit a housekeeping request to an additionally selected second housekeeper terminal 1307 at step S1340.

Thereafter, a gateway 1300 may determine a device status at step S1350. The device state may include a state of devices within the room and a battery state of devices. A device that transmits the status information to the gateway 1300 may include a device that houses a communication module. Thereafter, the gateway 1300 may transmit the device status information to the management server 1301 at step S1355. The management server 1301 may update a management list in response thereto at step S1360. Update of the management list may include addition of a related item of a device in which it is determined that management is required among the devices whose state is determined. The management server 1301 may transmit the updated management list to the second housekeeper terminal 1307 at step S1365 and may transmit the updated management list to the room inspector and manager terminal 1305 at step S1367. In this case, although not shown in the drawing, when the first housekeeper is still assigned to the same room, the management server 1301 may transmit the updated management list even to the first housekeeper terminal 1303. Further, when the terminal directly manages the management list, the management server 1301 may receive a device state at step S1355 and update the management list at step S1360.

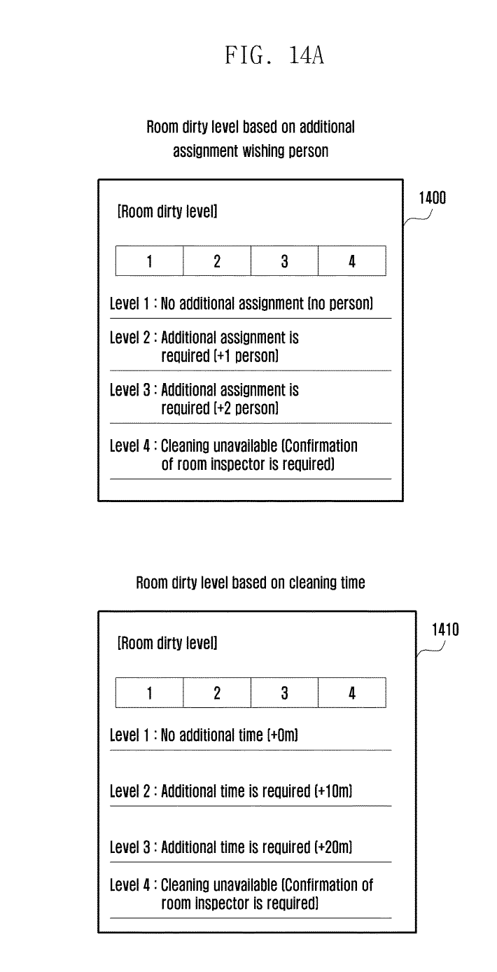

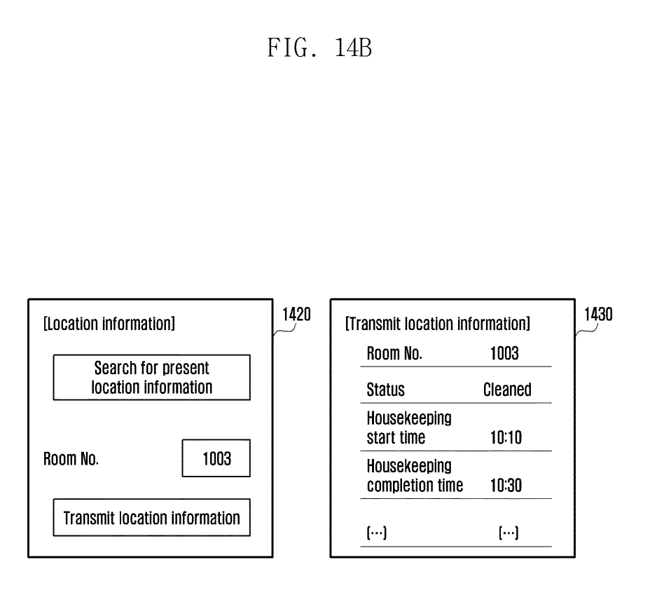

FIGS. 14A and 14B are diagrams illustrating example information for readjusting assignment of a housekeeper according to an example embodiment.

For example, FIG. 14A illustrates a screen in which a housekeeper inputs room dirty level information that uses for requesting additional person assignment or for scheduling.

FIG. 14A is a diagram illustrating a room dirty level of room data in which a housekeeper inputs at step S1310 of FIG. 13. The housekeeper may input a room dirty level based on additional assignment wishing person or may input a room dirty level based on a cleaning time. In order to receive an input of the room dirty level from the housekeeper, the terminal may display a screen 1400 that may receive an input of the room dirty level based on additional assignment wishing person and a screen 1410 that may receive an input of the room dirty level based on a cleaning time.

The screen 1400 that inputs a room dirty level based on an assignment person may display information about a room dirty level in which the housekeeper inputs when performing room cleaning based on an additional assignment person in which the housekeeper wishes. Information about such a wishing assignment person is transmitted to a room inspector and a manager. For example, Level 1 may represent that additional housekeeper assignment is not wished due to a low room dirty level. Level 2 may represent that assignment of one additional housekeeper is required due to an intermediate room dirty level, and Level 3 may represent that assignment of two additional housekeepers are required due to a high room dirty level. Level 4 may represent that cleaning is impossible and that confirmation of a room inspector is required due to a very high room dirty level. For example, a case in which sale is unavailable due to the reason such as facility damage may correspond to Level 4. Additionally, the housekeeper may transmit picture information of a room photographed by a camera while inputting the room dirty level to the management server and thus the picture information may be used as a material for object confirmation to an additional manpower request.

Thereafter, the screen 1410 that inputs a room dirty level based on a cleaning time may display information in which a housekeeper inputs a room dirty level based on an estimated additional consumption time. In such casein example, the room inspector and the manager, having received information about the additional consumption time may consider the information when readjusting/scheduling assignment of a housekeeper to a room.

A room dirty level based on the cleaning time will be exemplified. Level 1 may represent that an additional consumption time is not required due to a low room dirty level. Level 2 may represent that an additional consumption time of 10 minutes is required due to an immediate room dirty level. Level 3 may represent that an additional consumption time of 20 minutes is required due to a high room dirty level. Further, Level 4 may represent that cleaning is impossible and that confirmation of a room inspector is required due to a very high room dirty level.

FIG. 14B is a diagram illustrating an example method in which a management server dynamically changes a housekeeping status based on a location state of a housekeeper and adjusts additional assignment or scheduling. As described above, when the housekeeper manages a room, the housekeeper should manually input a housekeeping status of the room in a terminal thereof. However, in an example embodiment described with reference to FIG. 14B, when the housekeeper performs housekeeping, the housekeeper may transmit present location information to the management server using a terminal, and the management server may analyze a work advancing current status of a corresponding housekeeper based on the present location information.

For example, the housekeeper terminal may search for location information thereof and may display transmission of location information on a screen (1420). A management server, having received the location information may calculate a housekeeping start time (Ongoing input time) of a room of the housekeeper, a housekeeping completion time (Cleaned input time), and a cleaning consumption time, and may automatically change a housekeeping status of a room to Ongoing->Cleaned (1430).

For example, the management server may receive location information of a terminal of a housekeeper who gets out from a room 1002 and who gets in a room 1003, change a housekeeping status of the room 1002 to Cleaned, and change a housekeeping status of the room 1003 to Ongoing. Further, the management server may determine a housekeeping start time and a housekeeping completion time based on a change time of the housekeeping status. The management server may estimate a housekeeping completion time of a housekeeper based on history information of the determined management time, determine a work load, request an additional assignment person through comparison with another housekeeper, or request schedule readjustment. In the present example embodiment, it is unnecessary that a housekeeper manually changes a housekeeping status of a room and convenience can be thus provided.

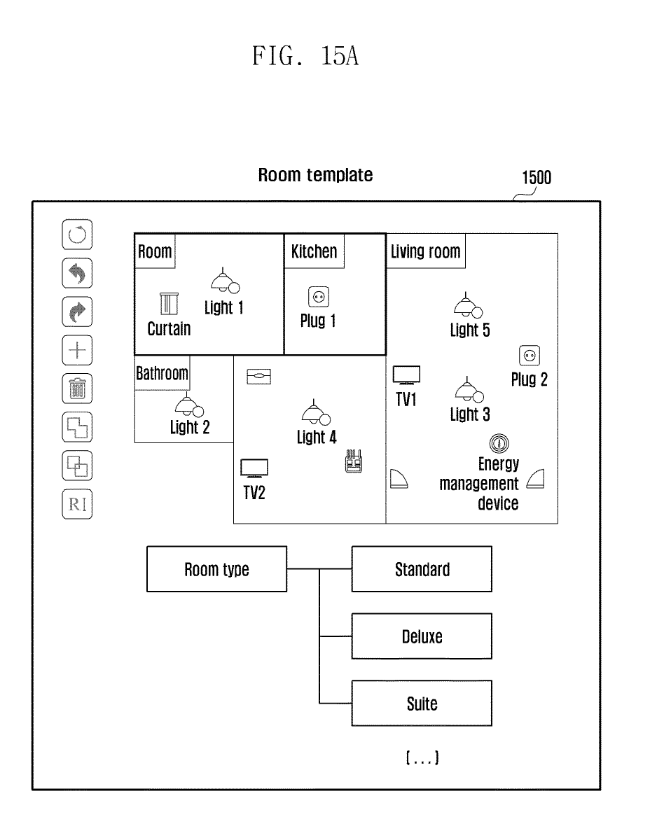

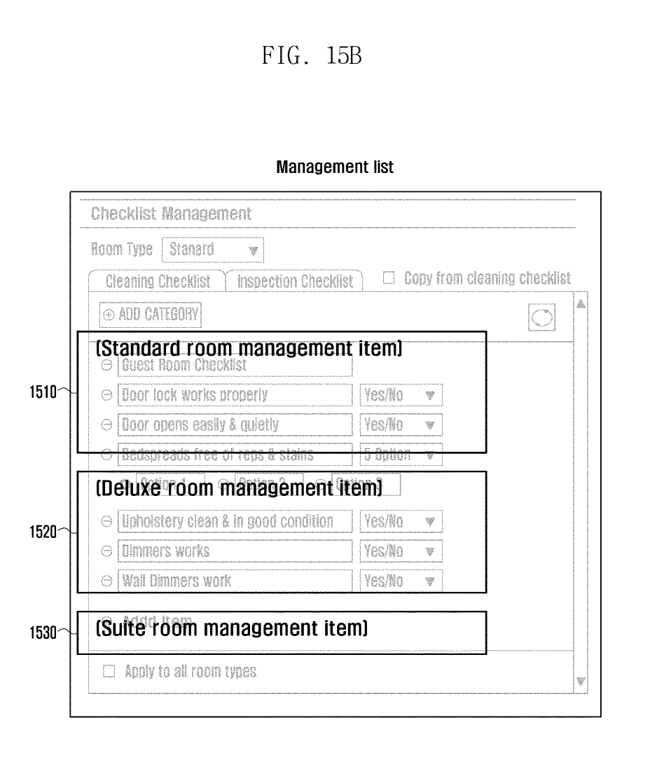

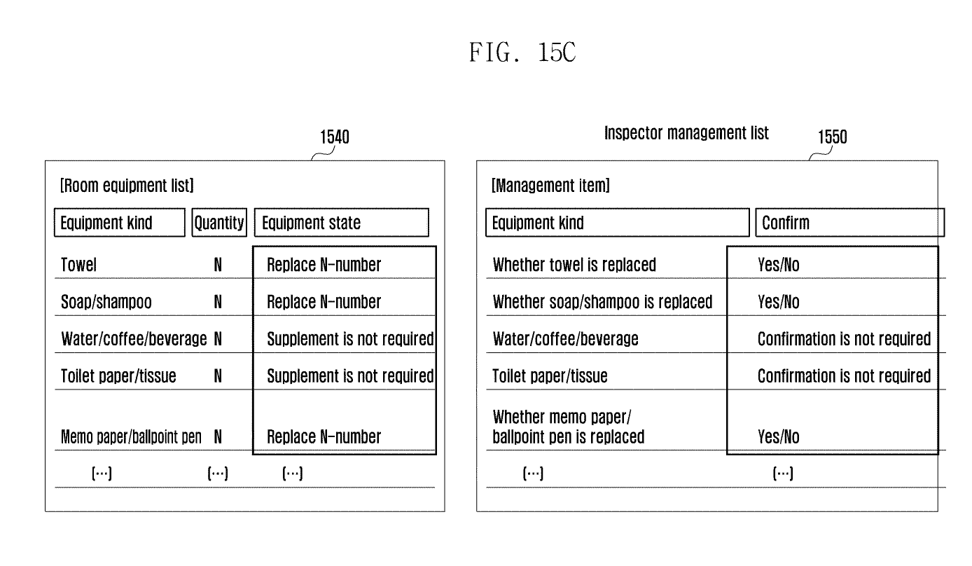

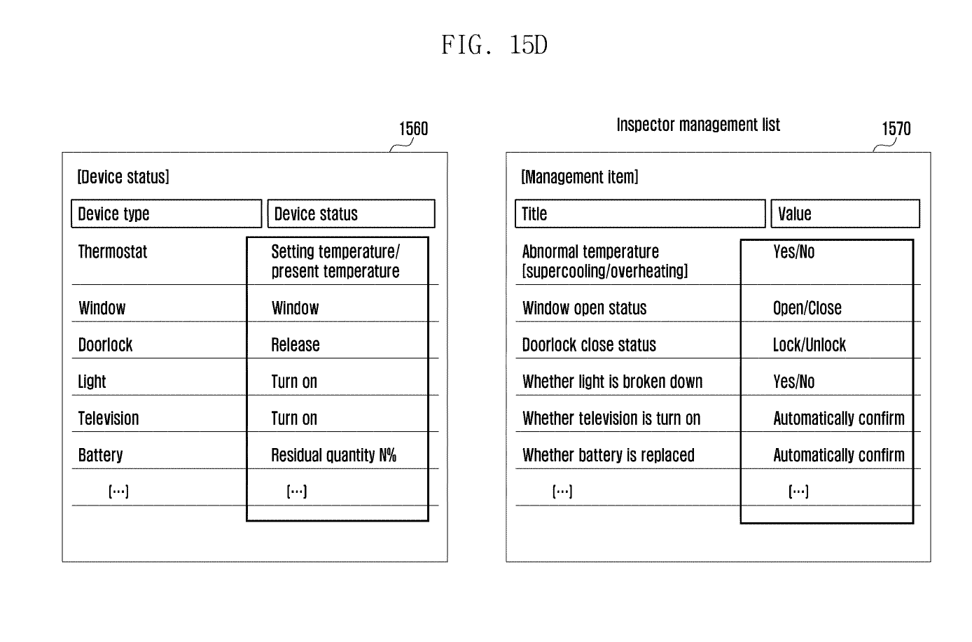

FIGS. 15A, 15B, 15C, and 15D are diagrams illustrating an example method in which a management server dynamically configures a management list that manages a room according to an example embodiment.

For example, FIGS. 15A and 15B are diagrams illustrating an example method of basically generating a management list form based on a room type. At the management server, a room template based on a previously designed and stored room type is stored. An element of a room template 1500 of FIG. 15A may include an area including a room, kitchen, and bathroom and a device including lighting and a television, and the area may include an attribute of an area name, a location, and an area size, and the device may include an attribute of a name, location, and state of a device, and a control function.

The management server may generate a management list based on the room template, and in this case, the management server may configure a management item within a management list in which a housekeeper and a room inspector should determine with reference to attribute information of the device and the area of a room template based on a room type and may define the item in a category unit. An illustration of a management list generated in this way is illustrated in FIG. 15B. For example, the management list may basically include one of a standard housekeeping item 1510, deluxe housekeeping item 1520, and suite housekeeping item 1530 based on the room type.

For example, the generated management list may generate a detailed unit management item within the room. For example, an area related management item may include a bedroom, bathroom, and entrance, and a device related management item may include a television, lighting, and window/door. Further, an equipment related management item within the room may include a towel, soap, shampoo, and toilet paper. Further, disposition order of a management item within a management list in a predetermined area may set in distance order or cleaning order from a room door. A management list generated in this way may be edited by a staff having an authority such as a manager. For example, the manager may receive a management list stored at the management server and edit a management item of the management list. When the housekeeper or the room inspector gets in a room, the management server may transmit the stored management list of a corresponding room to the housekeeper or room inspector terminal.

FIG. 15C is a diagram illustrating a room equipment related management item of a management list.

FIG. 15C is a diagram illustrating a screen 1540 of a housekeeper terminal or a device that performs a gateway function and a screen 1550 of a room inspector.

A screen displayed in a housekeeper terminal or a television screen 1540 that performs a gateway function of a room may display equipment current status information. When performing housekeeping, the housekeeper may input a room equipment state on the screen 1540 that displays information about an equipment within the room. Information about an equipment current status input to the housekeeper terminal or the television screen 1540 within the room may be transmitted to the management server. The management server, having received information about the changed equipment current status may edit a management item of a management list based on information about the equipment current status and may transmit the management list to a room inspector to which a corresponding room is assigned. For example, when the housekeeper replaces an equipment such as soap/shampoo and inputs information about an equipment current status to the terminal or the television, at a management list of the room inspector, a management item that determines replacement of soap/shampoo may be added.

FIG. 15D is a diagram illustrating a device related management item of a management list.

FIG. 15D is a diagram illustrating a screen 1560 of a housekeeper terminal or a device that performs a gateway function and a screen 1570 of the room inspector.

The screen displayed in the housekeeper terminal or the screen 1560 of a device that performs a gateway function within the room may display status information of a device. When performing housekeeping, the housekeeper may input status information of the device on the screen 1560 in which information about an equipment within the room is displayed. Status information of a device input to the housekeeper terminal or the television screen within the room may be transmitted to the management server.

When detecting necessity of management such as device abnormality or battery replacement based on the received status information, the management server may change a management item of a management list of a corresponding room. The management server may transmit the changed management list to a housekeeper and room inspector terminal to which a corresponding room is assigned.

For example, when a preset temperature of a thermostat to a present temperature is an abnormal temperature deviated from a reference threshold temperature, the management server may add a management item to determine whether supercooling or overheating to a management list. Further, the management server, having received information in which a window state is open may add a management item that instructs confirmation of a window state to the management list. Further, when information in which a battery residual quantity of any device is a predetermined numerical value or less is input, the management server may add a management item representing whether to replace a battery of a corresponding device to a management list.

Further, the management server compares a device state (housekeeping status: Dirty) before housekeeping of the housekeeper and a device state (housekeeping status: Cleaned) after cleaning based on a signal received from a gateway, determines a device abnormal state and whether to replace a battery and reflects this to a management list inspection result, thereby enabling the room inspector to efficiently perform inspection.

Further, the management server may dynamically configure the inspector's management item based on user information received from the RMS. For example, the management server may adjust a management item based on a stay person and a stay period or may add a management item on whether to provide a baby seating service according to whether a baby is accompanied. Further, the management server may adjust the inspector's management item based on a room dirty level input by the housekeeper. For example, as the housekeeper inputs a room dirty level to 4, when the room is in a sale unavailable situation, the management server may add a management item that instructs to determine whether a facility is damaged.

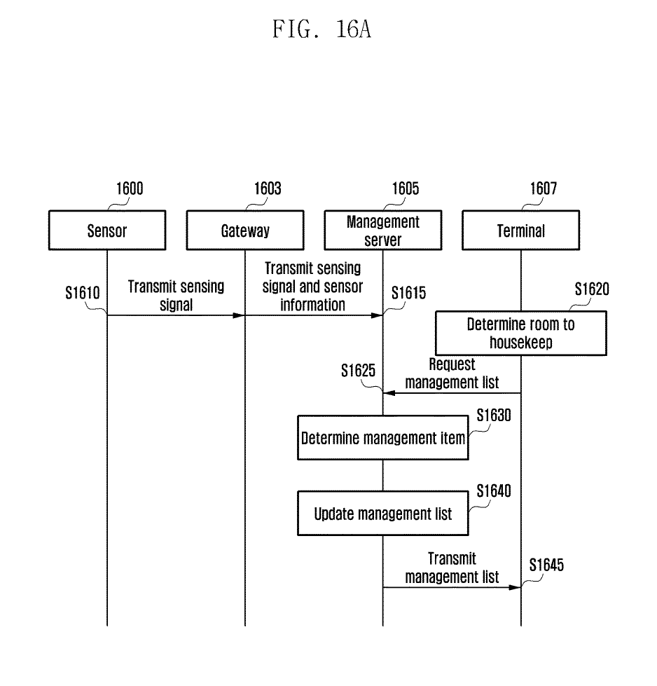

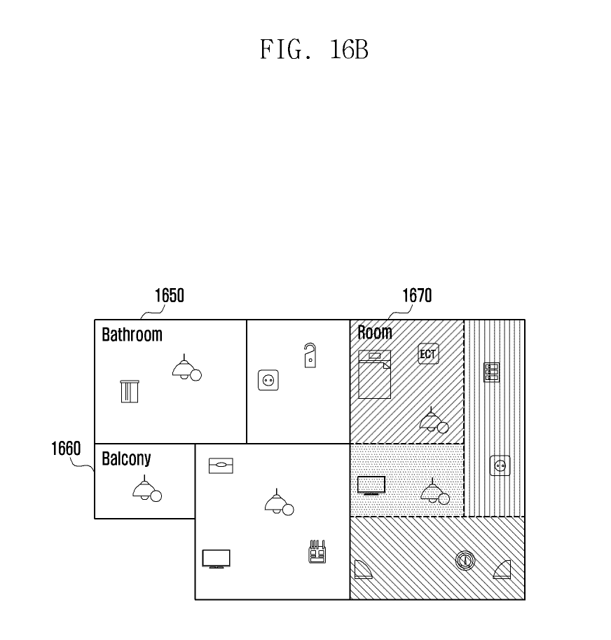

FIGS. 16A and 16B are diagrams illustrating an example method in which a management server dynamically configures a management list based on a sensing signal that collects within a room according to an example embodiment.

FIG. 16A is a message flow diagram illustrating an example operation for dynamically configuring a management list between a sensor 1600, gateway 1603, management server 1605, and terminal 1607. The terminal 1607 may include a terminal of a housekeeper or a room inspector assigned to a room. Further, a television that can display a screen within the room instead of the terminal 1607 may perform the same operation.

At least one sensor 1600 within the room may transmit a sensing signal to the gateway 1603 at step S1610. The sensing signal may indicate an electrical signal generated in response to stimulation input to a sensor within the room by at least one sensor 1600 within the room. Thereafter, the gateway 1603, having collected the electrical signal may transmit together a sensing signal and sensor information generated by the sensing signal to the management server 1605 at step S1615. The sensor information may include at least one of kind information and location information of the at least one sensor 1600. The sensor 1600 may include a sensor of a room guest's terminal or wearable device within the room as well as a sensor attached to a device and equipment within the room. The sensor 1600 may include a motion sensor, weight sensor, proximity sensor, and acceleration sensor. Further, the sensor 1600 may include a temperature detection sensor, current detection sensor, and access sensor. A kind of the listed sensor is an illustration and the disclosure is not limited to a kind of the listed sensor. The management server 1605 may store a sensing signal collected from the gateway 1603 of the room.

Thereafter, the terminal 1607 may determine a room to housekeep at step S1620. The terminal 1607 may determine a room based on an input received from a terminal user. Further, the management server 1605 may detect that a housekeeper or a room inspector enters into the room using the terminal user's location information and determine a room to housekeep. The terminal 1607 may request a management list of a room to housekeep to the management server 1605 at step S1625. In this example, the terminal 1607 may transmit information about a requesting room to the management server.

Thereafter, the management server 1605 may determine an item requiring housekeeping within the room received a request for the management list at step S1630. The item requiring housekeeping may include at least one of an area, device, and equipment related item within the room.

The management server 1605 may generate a basic management list based on a type of a room that received a request for the management list. This is similar to that described with reference to FIGS. 15A and 15B. Thereafter, the management server 1605 may update the generated basic management list according to an individual room status. The management server 1605 may determine an item requiring housekeeping within the room using the received sensing signal and sensor information.

For example, the management server 1605 may estimate an area of frequent guest use within the room to an area of a high dirty level based on information of a sensor, having transmitted a sensing signal to determine an area requiring housekeeping or may estimate a status of a device or an equipment to determine a device or an equipment requiring housekeeping.

For example, the management server 1605 may estimate a frequent use area using a motion sensor attached to a floor or a wall of the room. Further, the management server 1605 may acquire use frequency and use time information of the device using a proximity sensor installed at a device within the room, acquire use information of the device or equipment using the use frequency and use time information, and estimate a guest's frequent use area. The management server may estimate a guest's frequent use area to an area of a high pollution level and determine the area to a management area.

For example, the management server 1605 may determine an item requiring housekeeping according to a predetermined reference value of the number in which a movement of the motion sensor is detected. When the predetermined number or more of sensing signal is received from the motion sensor, a device or equipment to which a motion sensor is attached or an area at which the motion sensor is located may be determined to a management item.

Further, the management server 1605 may estimate whether an equipment is used, a use amount of an equipment, and a necessary supplement amount using a sensing signal received from a weight sensor attached to the equipment within the room.

Further, the management server 1605 may estimate whether an equipment is used, a use amount of an equipment, and a necessary supplement amount according to a predetermined reference value based on a change amount of a sensing signal received from the weight sensor. When a sensing signal received from the weight sensor is changed by a predetermined value or more, the management server 1605 may determine an equipment to which the weight sensor is attached or an area at which the equipment is located to a management item.

When the management server 1605 receives a sensing signal from a sensor attached to a device and equipment within the room, the management server 1605 may determine a special area requiring housekeeping within the room and determine device and equipment related management items without a manual input of a housekeeper, as described with reference to FIG. 15.

Further, by estimating a dirty level, the management server 1605 may determine a management item. For example, the management server 1605 may estimate an air dirty level using an odor sensor and a micro dust sensor located within the room and determine a management item requiring ventilation. Therefore, because a housekeeper within the room cannot detect, by adding an item that cannot manually input as a management item of a management list, the management server 1605 can more comfortably manage an environment within the room.

Further, the management server 1605 may additionally determine a management item in consideration of terminal information and a sensing signal received from a sensor attached to the room guest's terminal or wearable device. For example, the management server 1605 may additionally consider whether a room guest checks in and moving line history information within the room to enhance accuracy of estimation on an area of frequent guest use and may determine a housekeeping item for creating a room environment appropriate to a guest using the room guest's bio information.

The management server 1605 may update a management list based on a determined item requiring housekeeping at step S1640. For example, the management server 1605 may add the determined management item at the management list. Further, the management server 1605 may dispose the determined management item at the upper end within the already stored management list. The management server 1605 may transmit the updated management list to the terminal 1607 at step S1645.

Additionally, when the gateway 1603 has no sensing signal collected from the sensor 1600 within the room, the management server 1605 may update a management list based on previously input guest setting or a predetermined housekeeping manual.

FIG. 16B is a diagram illustrating an example of determining a management area within the room.

When receiving a sensing signal and information of a sensor, having transmitted the sensing signal, a management server may determine a location of the sensor, having transmitted the sensing signal based on a previously stored room template. As described with reference to FIG. 16A, when a sensing signal satisfies a predetermined reference, the management server may determine an area in which a sensor is located to a management area. For example, the management server receives a sensing signal satisfying a predetermined reference from sensors located at a bathroom 1650, but when the management server does not receive a sensing signal satisfying a predetermined reference from sensors located at a balcony 1660, the management server may determine only the bathroom 1650 to a management area. Further, the management server may determine a management area using a room dirty level determined based on a sensing signal transmitted by the sensor.

Further, the management server may determine a subdivided area within a physical area as well as a physically separated area such as the bathroom 1650 and the balcony 1660 to a management area. For example, the management server may determine only a partial area in which a sensor transmitting a sensing signal satisfying a predetermined reference exists in a room 1670 to a management area.

The management server may determine a device, equipment, and area requiring housekeeping based on a sensing signal received within the room, reflect the device, equipment, and area to a management list in which the housekeeper and the room inspector may determine and thus enable the housekeeper and the room inspector to previously determine a portion requiring housekeeping and thus efficiency of management is enhanced.

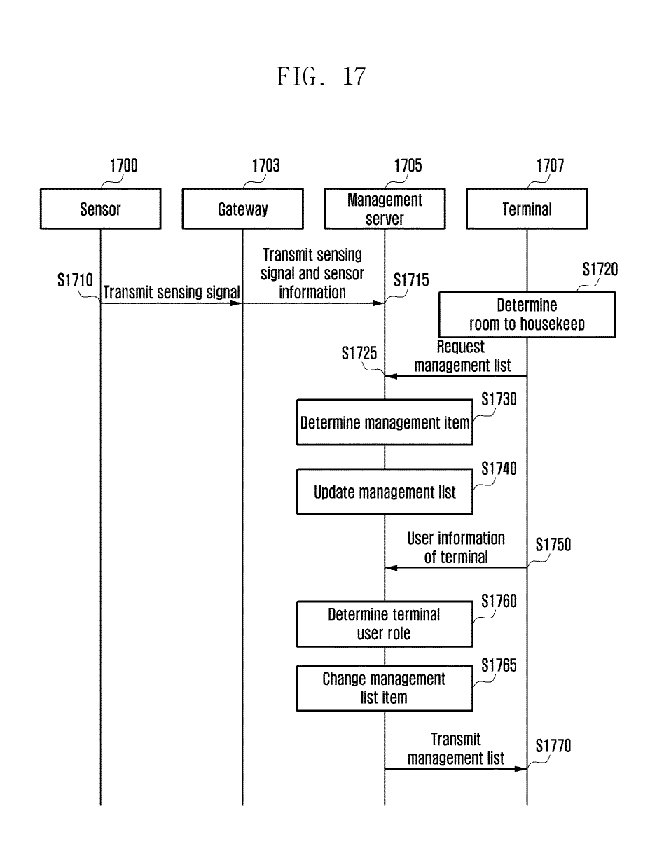

FIG. 17 is a message flow diagram illustrating an example method of dynamically configuring a management list based on user information of a terminal and a sensing signal in which a management server collects within a room according to an example embodiment.

FIG. 17 is a message flow diagram illustrating operation for dynamically configuring a management list between a sensor 1700, gateway 1703 within a room, management server 1705, and terminal 1707. Steps S1710 to S1740 of FIG. 17 are the same as or similar to steps S1610 to S1640 of FIG. 16A, and hereinafter, subsequent steps will be described.

The management server 1705 may update a management list at step S1740 and receive user information of the terminal 1707 from the terminal 1707 at step S1750. Selectively, the management server 1705 may update a management list and request user information of a terminal to the terminal 1707, having transmitted a management list request. User information of the terminal may include terminal user role information. The user role information may include a housekeeper, room inspector, and manager, and a detailed role of the housekeeper may be subdivided and may include assignment information of cleaning assignment and equipment assignment. Further, the user information of a terminal may include location information of the terminal user.

The management server 1705 may determine the terminal user role based on the received user information of a terminal at step S1760. Thereafter, the management server 1705 may change a management item within the management list based on the determined terminal user role at step S1765. For example, an item related to the user role may be subdivided, and an item unrelated to the user role may be deleted. For example, when the terminal user role is a housekeeper who performs cleaning, a cleaning related item may be subdivided and an equipment related item may be deleted. Further, when the terminal user role is a room inspector, a management result check related item may be configured in detail.

Further, the management server 1705 may change a management item of the management list based on location information of the terminal user received at step S1750. For example, the management server 1705 may include only a management item of an area adjacent to the terminal user in a management list based on a location of the terminal 1707 within the room. Alternatively, the management server 1705 may dispose a management item of an area adjacent to a user within the room at the upper end of a management list of the room. Thereafter, the management server 1705 may transmit the management list to the terminal 1707 at step S1770. In this way, by providing a management list changed to optimize to the terminal user role or location to the terminal, housekeeping can be further efficiently performed.

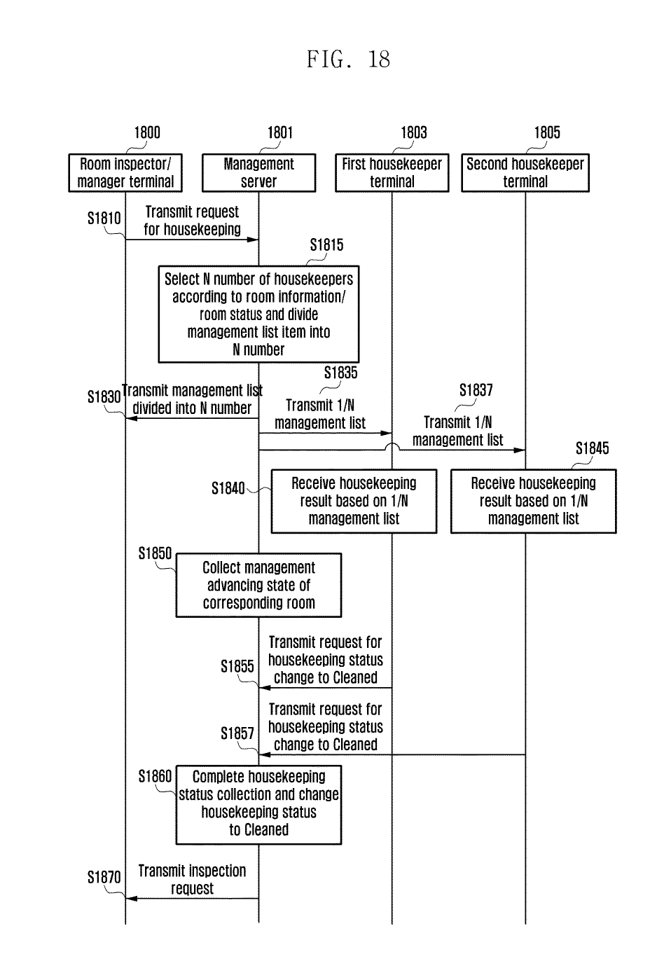

FIG. 18 is a message flow diagram illustrating an example method of dividing and collecting a management list to a plurality of housekeepers within the same room according to an example embodiment.

A room inspector and manager terminal 1800 may transmit a request for housekeeping to a management server 1801 at step S1810. The management server 1801 may select the N number of housekeepers based on room information and a room status and divide a management list item into the N number at step S1815. The management server 1801 may determine a work load or a management consumption time of a housekeeper and divide the management list item into the N number. Further, the management server 1801 may divide a management list item into the N number based on a detailed role of the housekeeper or a location of a housekeeper within the room. The management server 1801 may transmit a management list divided into the N number to the room inspector and manager terminal 1800 at step S1830. Further, when the housekeeper selected at step S1815 is a first housekeeper and a second housekeeper, the management server 1801 may transmit the divided and assigned 1/N management list to a first housekeeper terminal 1803 at step S1835 and transmit the divided and assigned 1/N management list to a second housekeeper terminal 1805 at step S1837. The first housekeeper terminal 1803 may receive a housekeeping result from the housekeeper based on the 1/N management list at step S1840, and the second housekeeper terminal 1805 may receive a housekeeping result from the housekeeper based on the 1/N management list at step S1845.

When the first housekeeper terminal 1803 and the second housekeeper terminal 1805 transmit the housekeeping result to the management server 1801, the management server 1801 may collect a management advancing state of a corresponding room at step S1850. When receiving an input that housekeeping has been complete from housekeepers, the first housekeeper terminal 1803 may transmit a request for a housekeeping status change to Cleaned to the management server 1801 at step S1855 and the second housekeeper terminal 1805 may transmit a request for a housekeeping status change to Cleaned to the management server 1801 at step S1857. Thereafter, when receiving a request for a housekeeping status change to Cleaned from the selected N number of housekeepers and completing housekeeping status collection, the management server 1801 may change a housekeeping status of the room to Cleaned at step S1860. Thereafter, the management server 1801 may transmit an inspection request to the room inspector terminal 1800 at step S1870.

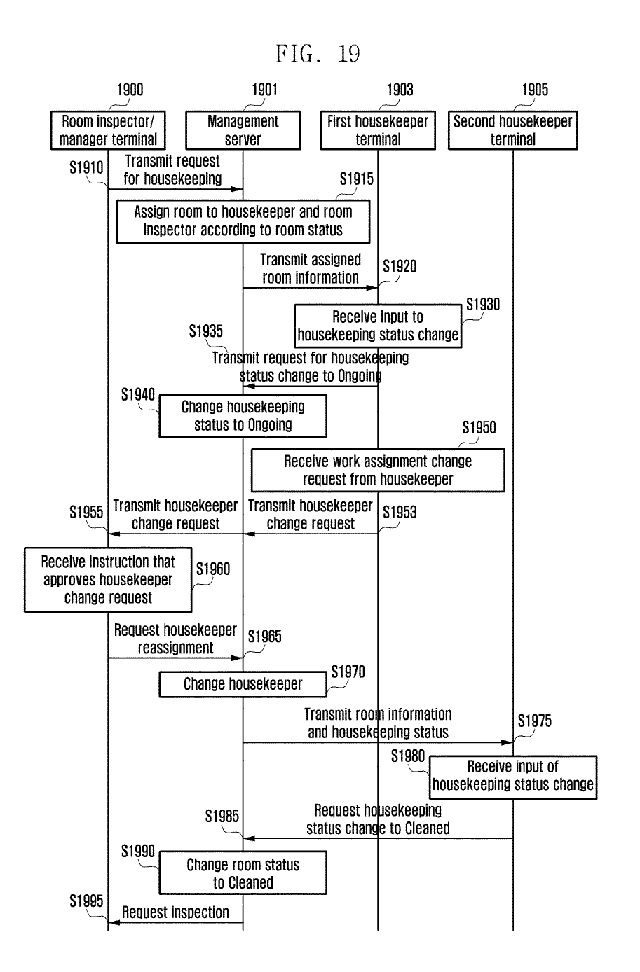

FIG. 19 is a message flow diagram illustrating an example process in which a housekeeper who manages an already assigned room requests a change of a housekeeper, thereby changing the housekeeper according to an example embodiment.

When receiving an input of a request for housekeeping from a room inspector and manager, a room inspector and manager terminal 1900 may transmit a request for housekeeping to a management server 1901 at step S1910. In this example, the request may include information of a room that receives the request. The management server 1901 may assign a room to a housekeeper and a room inspector according to a room status in response thereto at step S1915 and may transmit assigned room information to a first housekeeper terminal 1903 at step S1920. When the first housekeeper starts housekeeping of a room, the management server 1901 may input a room status change to Ongoing to the terminal, and the first housekeeper terminal 1903 may receive an input to a housekeeping status change at step S1930.

Thereafter, the first housekeeper terminal 1903 may transmit a request for a housekeeping status change to Ongoing to the management server 1901 at step S1935, and the management server 1901 may change a housekeeping status of a corresponding room to Ongoing in response thereto at step S1940. Thereafter, the first housekeeper terminal 1903 may receive a work assignment change request from the housekeeper at step S1950. The work assignment change request includes additional assignment request or a replacement request of a housekeeper by a first housekeeper. In this example, the first housekeeper terminal 1903 may transmit a housekeeper change request to the management server 1901 at step S1953 and the management server 1901 may transmit a housekeeper change request to the room inspector or manager terminal 1900 at step S1955.

In this example, the room inspector or manager terminal may display and notify a message to the housekeeper change request. Thereafter, when receiving an instruction that approves a housekeeper change request from the room inspector or the manager at step S1960, the room inspector or manager terminal 1900 may request housekeeper reassignment to the management server 1901 at step S1965. The management server 1901 may newly assign and change a housekeeper to the requested room in response thereto at step S1970. When assigning a new housekeeper, the management server 1901 may select a housekeeper based on housekeeper related information, as described with reference to S615 of FIG. 6.

Thereafter, the management server 1901 may transmit assigned room information and a housekeeping status of a corresponding room to a second housekeeper terminal 1905 at step S1975. This notifies a second housekeeper terminal assigned while Ongoing of a housekeeping status of a room. Thereafter, when the second housekeeper terminal 1905 receives an input of a housekeeping status change to Cleaned from a second housekeeper at step S1980, the second housekeeper terminal 1905 may request a housekeeping status change to the management server 1901 at step S1985. The management server 1901 may change a room status to Cleaned in response thereto at step S1990. Thereafter, the management server 1901 may request an inspection of a corresponding room in which housekeeping is complete to the room inspector terminal 1900 at step S1995.

Further, in an example embodiment, it is described that a subject that performs the foregoing management list generation operation and operation of dynamically configuring an item of a management list is a management server, but the disclosure is not limited thereto and another device can perform the operation. For example, the housekeeper or room inspector terminal may perform the operation. For example, when a room template according to a room type is previously designed and stored at the housekeeper or room inspector terminal, the housekeeper or room inspector terminal may generate a management list based on the room template. A change and application of operation of the management server to correspond to operation of another device will become apparent to a person of ordinary skill in the art.

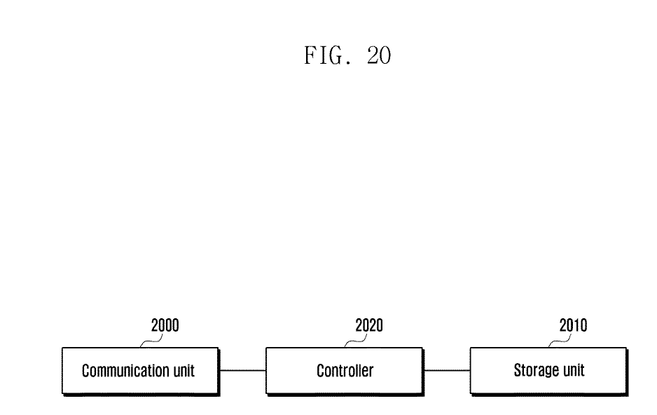

FIG. 20 is a block diagram illustrating an example internal structure of a server according to an example embodiment.

For example, the server may include a management server and include a communication unit (e.g., including communication circuitry) 2000, storage unit 2010, and controller 2020.

The communication unit 2000 may use various communication circuitry to transmit and receive necessary information when the server performs operation according to an example embodiment. For example, the communication unit 2000 may include communication circuitry that may be connected to a device that performs a function of a gateway within the room, a housekeeper terminal, room inspector terminal, and manager terminal to transmit and receive information about a room status, a request for housekeeping, and a housekeeping status. Further, the communication circuitry of the communication unit 2000 may transmit the information assigned to a room by the controller 2020 to a terminal of a housekeeper and a terminal of a room inspector. Further, the communication circuitry of the communication unit 2000 may transmit information received from the housekeeper terminal and the room inspector terminal to the controller 2020.

The storage unit 2010 may store necessary information when the server performs operation according to an example embodiment. The storage unit 2010 may store information received by the communication unit 2000. The storage unit 2010 may store information about a room status, a request for housekeeping, and a housekeeping status of a room. Further, the storage unit 2010 may provide stored information to the controller 2020.

The controller 2020 may include processing circuitry configured to determine a room status, assign a housekeeper to the room based on the room status, transmit the room information to the housekeeper terminal, and receive and update a housekeeping status from the housekeeper terminal. Further, the controller 2020 may assign a room inspector for housekeeping of the housekeeper based on the room status and transmit the room information to the room inspector terminal.

Further, the controller 2020 may receive a housekeeping request from a gateway related to a random room, assign at least one housekeeper to a room that receives the housekeeping request based on at least one housekeeper related information, and transmit information about a room that receives the housekeeping request to the assigned housekeeper.

The controller 2020 may determine information about a work load of the at least one housekeeper, readjust work assignment of at least one housekeeper based on information about a work load of the at least one housekeeper, and transmit information about the room to the at least one housekeeper based on readjustment of the work assignment. The controller 2020 may determine location information of the assigned housekeeper and update a housekeeping status of the room based on the location information. The controller 2020 may generate a management list related to housekeeping based on the room type, transmit the management list to the housekeeper, and change a management list based on a change request when receiving a change request for the management list.

Further, the controller 2020 may receive at least one sensing signal from at least one sensor, determine a management item based on at least one of the received at least one sensing signal, and update an already generated management list of the room based on the determined management item. Further, the controller 2020 may receive a request for a management list from a terminal, receive user information of a terminal from the terminal, and change a management item of the management list based on the user information of the terminal.

Further, the controller 2020 may estimate an area having the high use frequency of a room guest based on location information of a sensor, having transmitted the sensing signal and determine an area having the high use frequency to a management item. Further, the controller 2020 may add the determined management item to the management list and change a disposition of the management list based on the determined management item.

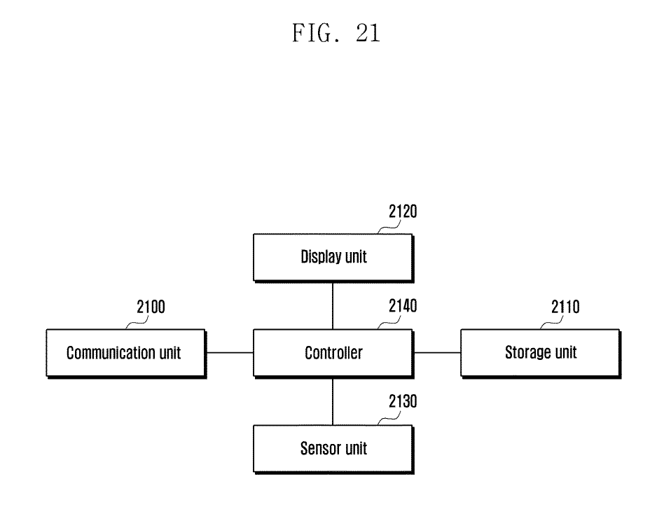

FIG. 21 is a block diagram illustrating an example internal structure of a terminal according to an example embodiment.

For example, the terminal may include a communication unit (e.g., including communication circuitry) 2100, storage unit 2110, display unit (e.g., including a display panel and driving circuitry) 2120, sensor unit 2130, and controller 2140.

The communication unit 2100 may include various communication circuitry configured to transmit and receive necessary information when the terminal performs operation according to an example embodiment. For example, the communication circuitry of the communication unit 2100 may be connected to a server to transmit and receive information about a room status, a request for housekeeping, and a housekeeping status of a room. Further, the communication circuitry of the communication unit 2100 may transmit information input by a user through the display unit 2120 to the server. Further, the communication circuitry of the communication unit 2100 may transmit information received from the server to the controller 2140.

The storage unit 2110 may store necessary information when the terminal performs operation according to an example embodiment. The storage unit 2110 may store information received by the communication unit 2100. The storage unit 2110 may store information about a room status, a request for housekeeping, and a housekeeping status of a room. Further, the storage unit 2110 may provide stored information to the controller 2140.

The display unit 2120 may include a display panel configured to display necessary information when the terminal performs operation according to an example embodiment. Further, the display unit 2120 may include a touch screen that may receive an input from a user. For example, the display unit 2120 may display information received from the server and display information in response to the user input. For example, the display unit 2120 may display room information and housekeeping request information received from the server and display a screen corresponding to an input that requests a change of a housekeeping status of a room input by the user.

The sensor unit 2130 may include the sensor module to receive a necessary input when the terminal performs operation according to an example embodiment and may include at least one of, for example, a gesture sensor, gyro sensor, magnetic sensor, acceleration sensor, grip sensor, proximity sensor, and Red, Green, and Blue (RGB) sensor. The sensor unit 2130 may further include a control circuit for controlling at least one sensor therein. An additional sensor or device in addition to the described illustration may be included according to an example embodiment.

The controller 2140 may include processing circuitry configured to receive the room information from the server, to display the room information on a screen, to receive an input that changes a housekeeping status of a room from a user, and to transmit a request for a housekeeping status change of a room to the server in response to the input. Further, the controller 2140 may be configured to receive the room information from the server to display the room information on a screen, to receive an input that changes a housekeeping status of a room from a user, and to transmit a request for a housekeeping status change of a room to the server in response to the input.

Further, operations to be performed by the communication unit 2000, storage unit 2010, and controller 2020 of a management server described with reference to FIG. 20 may be changed and performed for the communication unit 2100, storage unit 2110, and controller 2140, which are an internal structure corresponding to a terminal. It will become apparent to a person of ordinary skill in the art to change and apply operation of the management server for the terminal.

Although various example embodiments have been described in detail hereinabove, it should be clearly understood that many variations and modifications of the disclosure herein described, which may appear to those skilled in the art, will still fall within the spirit and scope of the example embodiments of the disclosure as defined in the appended claims.

What is claimed is:

1. A method of managing a room, the method comprising:
receiving at least one sensing signal from at least one sensor;
determining a management item based on at least one of the received at least one sensing signal; and
updating an already generated management list of the room based on the determined management item.

2. The method of claim 1, further comprising:
receiving a request for a management list from a terminal;
receiving user information of the terminal from the terminal; and
changing a management item of the management list based on the received user information of the terminal.

3. The method of claim 1, wherein the management item comprises at least one of an area related item, a device related item, and an equipment related item and is determined based on a transmission number of the sensing signal or an amount of change of information transmitted through a sensing signal.

4. The method of claim 1, further comprising:
estimating an area in which a use frequency is high based on location information of the sensor that transmitted the sensing signal; and
determining an area having the high use frequency to a management item.

5. The method of claim 1, wherein updating an already generated management list of the room based on the determined management item comprises at least one of addition of the determined management item to the management list and change of disposition of the management list based on the determined management item.

6. A server configured to manage a room, the server comprising:
communication circuitry configured to transmit and receive a signal; and
a controller configured to receive at least one sensing signal from at least one sensor and to determine a management item based on at least one of the received at least one sensing signal and to update an already generated management list of the room based on the determined management item.

7. The server of claim 6, wherein the controller is configured to receive a request for a management list from a terminal, to receive user information of the terminal from the terminal, and to change a management item of the management list based on the received user information of the terminal.

8. The server of claim 6, wherein the management item comprises at least one of an area related item, a device related item, and an equipment related item and is determined based on a transmission number of the sensing signal or an amount of change of information transmitted through a sensing signal.

9. The server of claim 6, wherein the controller is configured to estimate an area in which a use frequency is high based on location information of a sensor, having transmitted the sensing signal and to determine an area having the high use frequency to a management item.

10. The server of claim 6, wherein the controller is configured to control at least one of addition of the determined management item to the management list and change of disposition of the management list based on the determined management item.

11. The server of claim 7, wherein the user information comprises at least one of user role information and user location information.

12. A method in which a server is configured to manage a room in a room management system comprising at least one terminal and a gateway, the method comprising:
determining a room status related to a room guest;
assigning a housekeeper to the room based on the room status;
transmitting room information to a terminal of the housekeeper assigned to the room; and
receiving a housekeeping status from the housekeeper terminal and updating the housekeeping status.

13. The method of claim 12, further comprising:
assigning a room inspector to housekeeping of the housekeeper based on the room status; and
transmitting the room information to a room inspector terminal.

14. The method of claim 12, wherein the housekeeping status of the room comprises a housekeeping status and an available status of a housekeeper.

15. The method of claim 12, further comprising:
receiving a housekeeping request from a gateway corresponding to a random room;
assigning at least one housekeeper to a room that receives the housekeeping request based on at least one housekeeper related information; and
transmitting information about a room that receives the housekeeping request to the assigned housekeeper.

16. A server configured to manage a room in a room management system comprising at least one terminal and a gateway, the server comprising:
communication circuitry configured to transmit and receive information; and
a controller configured to determine a room status related to a room guest and to assign a housekeeper to the room based on the room status and to transmit room information to a housekeeper terminal and to receive a housekeeping status from the housekeeper terminal to update the housekeeping status.

17. The server of claim 16, wherein the controller is configured to assign a room inspector to housekeeping of the housekeeper based on the room status and to transmit the room information to a room inspector terminal.

18. The server of claim 16, wherein the housekeeping status of the room comprises a housekeeping status and an available status of a housekeeper.

19. The server of claim 16, wherein the controller is configured to receive a housekeeping request from a gateway corresponding to a random room, to assign at least one housekeeper to a room that receives the housekeeping request based on at least one housekeeper related information, and to transmit information about the room that receives the housekeeping request to the assigned housekeeper.

20. A terminal configured to manage a room in a room management system comprising at least one terminal and a gateway, the terminal comprising:
communication circuitry configured to transmit and receive information; and
a display unit configured to display at least one item related to the information; and
a controller configured to receive room information from a server to control the display to display the room information on a screen and to receive an input that changes a housekeeping status of a room and to transmit a request for a housekeeping status change of the room to a server in response to receiving the input.
